(19) United States
(12) Patent Application Publication
(10) Pub. No.: US 2025/0326251 A1
(43) Pub. Date: Oct. 23, 2025

(54) HUB SYSTEM, METHOD AND DEVICE WITH ADJUSTABLE DEADBAND AND TIMED ENGAGEMENT

(71) Applicant: The Hive Global, Inc., Taichung (TW)

(72) Inventors: Greg Thrash, Petaluma, CA (US); George Dubois, San Luis Obispo, CA (US); Joel Peters, Taichung (TW)

(21) Appl. No.: 19/255,353

(22) Filed: Jun. 30, 2025

Related U.S. Application Data
(63) Continuation-in-part of application No. 18/507,362, filed on Nov. 13, 2023.
(60) Provisional application No. 63/425,251, filed on Nov. 14, 2022.
(60) Provisional application No. 63/666,847, filed on Jul. 2, 2024.

(51) Int. Cl. B60B 27/04; B60B 27/00; B60B 27/02

(52) U.S. Cl. CPC B60B 27/047; B60B 27/023; B60B 27/0026; B60B 2900/3312

(57) ABSTRACT

A freewheel hub having a non-zero deadband distance in order to reduce or eliminate pedal kickback. The deadband distance is able to have or be adjusted to a desired length and the engagement timing is able to be adjusted to a desired alignment.

### RELATED APPLICATIONS

This patent application claims priority under 35 U.S.C. 119(e) of the co-pending U.S. Provisional Patent Application No. 63/666,847, filed Jul. 2, 2024, entitled “BICYCLE FREEWHEEL MECHANISM WITH ADJUSTABLE ENGAGEMENT AND TIMED ENGAGEMENT,” and is a continuation-in-part of the co-pending U.S. patent application Ser. No. 18/507,362, filed Nov. 13, 2023, entitled “HUB SYSTEM, METHOD AND DEVICE WITH ADJUSTABLE DEADBAND,” which claims priority under 35 U.S.C. 119(e) of the U.S. Provisional Patent Application No. 63/425,251, filed Nov. 14, 2022, entitled “SILENT BICYCLE FREEWHEEL HUB WITH ADJUSTABLE ENGAGEMENT DEADBAND,” all of which are hereby incorporated by reference.

### FIELD OF THE INVENTION

The present invention is generally directed to hubs. More specifically, the present invention is directed to a freewheel hub whose deadband and engagement is able to be adjusted as desired.

### BACKGROUND OF THE INVENTION

Most bicycles today utilize a freewheel hub in the rear wheel to allow the rear wheel to “freewheel” or roll forward without requiring the rest of the bicycle drivetrain to move continuously. A typical freewheel hub uses one or more spring-loaded pawls mounted to a freehub body, moving inside a toothed ratchet gear attached to the hub shell. As the bicycle rolls forward, the pawls “ratchet” across the teeth of the toothed ratchet gear, disconnecting the bicycle cassette, chain, sprocket and cranks from the rear wheel.

When the rider resumes forward pedaling, there will be a certain amount of relative movement between the freehub body and the hub shell prior to a spring loaded pawl engaging with the toothed ratchet gear. This relative motion and/or a distance thereof is the deadband of the ratchet mechanism. Specifically, the deadband is able to be the mechanical distance the freehub body may move and/or rotate relative to the toothed ratchet gear before hub engagement occurs. In a traditional freewheel hub, this deadband distance is dependent on the number of teeth in the toothed ratchet gear. Typical toothed ratchet gears have between 12 and 70 teeth, sometimes more. In this traditional hub design, the deadband distance can often be zero or close to zero based on the number of ratchet teeth. Depending on when and how fast the rider begins pedaling (and thus begins rotating the freehub in the engagement direction), and how fast the rider is coasting at the time, there will be a time delay before torque is transferred from the bicycle cassette to the bicycle wheel (due to the engagement of the pawls of the freewheel with the ratchet gear of the hub shell. However, the contribution to that time from the freehub design can most easily be considered in mechanical terms, and the mechanical deadband is a direct input to this time delay.

A drawback of the freehubs having a zero or close to zero deadband is observed in the form of pedal kickback, in particular when a freewheel hub is used with a full-suspension bicycle. A full-suspension bicycle mounts the rear wheel on a swingarm or linkage, which allows the rear wheel to move up and down as the bicycle traverses bumps in the road or trail. Typical full suspension linkages include a certain amount of chainstay length growth as the suspension moves through its travel, where the chainstay length is the distance between the rear hub axle and the bicycle crankset spindle. As the suspension compresses, this distance grows, and since the bicycle chain traverses this distance from the crank chainring to the bicycle cassette, the chain will have tension applied to it as the chainstay length grows.

Under certain circumstances, a rider might be coasting with their weight on the bicycle pedals when a particularly large and abrupt compression is induced in the suspension, for instance if the rider rides their bicycle over a large bump at high speed, or lands off a jump and the suspension must absorb a large amount of energy quickly. Under these circumstances, the chain tension from chainstay length growth will rotate the freewheel forward quickly with great force, and may cause the freewheel ratchet mechanism to engage. If the rear wheel is in contact with the ground, the chain force will counteract the suspension movement and will reduce the efficiency of the suspension system in absorbing bump force. The chain force will also apply a reversing torque to the bicycle pedal crank, which may be felt by the rider as “pedal kickback,” wherein pedal kickback denotes both the sensation of pedal movement felt by the rider, as well as the reduction in suspension efficiency owing to the momentary chain load in the system.

The likelihood of pedal kickback in this scenario is increased by an increase in the number of ratchet teeth in the freewheel hub ratchet because it reduces the deadband distance of the system. Thus, traditional freewheel hubs have the drawback of the rider being likely to experience pedal kickback which is only exacerbated when combined with a full-suspension bicycle. Indeed, certain hubs use a sprag-clutch engagement mechanism instead of ratchet pawls, and indeed they reduce the deadband distance to zero. These hubs would therefore be most likely to experience pedal kickback under rapid suspension movements. Bicycles with more suspension travel and large chainstay length growths will also be more likely to experience pedal kickback. Also it should be obvious that the number of teeth on the toothed crank sprocket and the toothed cassette sprocket in use on rapid suspension movement will have an effect on pedal kickback force, since the resting position of the chain is controlled by the relative sizes of these sprockets, and the gear ratio between those two sprockets will affect the leverage the rear wheel has over the pedal crank, and vice versa.

Another effect related to hub deadband on full suspension bicycles may be observed, wherein vibrations in the bicycle chain are transmitted to the bicycle crank and pedals via the bicycle chainring. There are able to be two spans of chain traversing between the bicycle cassette mounted to the rear wheel, and the bicycle chainring attached to the bicycle crank, an upper and lower span. The upper span of chain transmits driving force to the rear wheel during pedaling, and the lower span returns the moving chain back to the bottom of the cassette.

When freewheeling and riding over rough terrain, it may be observed that both upper and lower spans of chain vibrate between the cassette and chainring. Under some circumstances where the hub deadband is small, vibrations are large, and bicycle speed is not over-running the rear hub speed, these chain vibrations may be amplified and exacerbated by the rear hub ratchet mechanism, generating additional audible noise and perceptible vibration as the rear ratchet is engaged and disengaged by high-frequency vibrations in the chain. Bicycle chains are able to be made of steel, and therefore can be imparted with a significant amount of momentum from bicycle movement. This momentum will be dispersed into the chainring, cassette, wheel and bicycle as it is generated.

### SUMMARY OF THE INVENTION:

A freewheel hub having a non-zero and/or invariant deadband distance (in addition to the inherent linear variable deadband attributable to the hub ratchet mechanism) in order to reduce or eliminate pedal kickback. This allows the freehub body to always move through a prescribed free motion before hub engagement, regardless of the relative position of the freehub body and the hub shell, and regardless of the number of teeth in the freehub ratchet mechanism. In other words, it sets the lowest value for deadband motion to a repeatable, positive amount, rather than zero. The deadband distance is able to have and/or be adjusted to a desired length by adjusting a deadband gap inside the hub. Additionally, while coasting, the added deadband in the hub ratchet mechanism allows the chain to vibrate freely without transmitting said vibrations to the bicycle crank and rear wheel. This reduction in noise and vibration gives the rider better control over the bicycle. Further, the invariant deadband allows the cassette to “rock” backward and forward while coasting without engaging the freehub mechanism as the bicycle coasts forward. This rocking motion changes the vibrational characteristics of the chain and drivetrain, which the rider perceives as smoother and more predictable.

A first aspect is directed to a hub system. The system comprises a wheel including a hub shell assembly, the hub shell assembly having a central aperture for receiving an axle, a ratchet gear bore and a toothed ratchet gear positioned within the ratchet gear bore, a freehub assembly including an outer hub sprocket attachment feature and a pawl support member, the pawl support member having a central axis, a plurality of pawl coupling bases and a plurality of primary pawls pivotably coupled to the pawl coupling bases along an arc about the central axis and a pawl actuator assembly having an actuator body, a central hole extending through the actuator body for receiving the axle and a plurality of lobes protruding from a perimeter of the actuator body away from the central hole, wherein at least one of the lobes includes a ratchet member that extends from the at least one lobe away from the central hole, wherein the plurality of primary pawls are positioned within the toothed ratchet gear, each lobe of the lobes of the pawl actuator assembly is positioned along the arc between two of the primary pawls, and when the hub shell assembly moves about the central aperture in a first direction relative to the pawl actuator assembly, the ratchet member slidably contacts the toothed ratchet gear and the primary pawls do not contact the toothed ratchet gear.

In some embodiments, when the hub shell assembly rotates about the central aperture in a second direction relative to the pawl actuator assembly, the ratchet member engages a tooth of the toothed ratchet gear such that the pawl actuator assembly begins to move with the hub shell assembly about the central aperture relative to the freehub assembly. In some embodiments, upon contacting the primary pawls when moving in the second direction, the lobes of the pawl actuator assembly cause the primary pawls to pivot away from the central axis until the primary pawls each engage a different tooth of the toothed ratchet gear. In some embodiments, the pawl support member has a plurality of openings along the arc having differing lengths, wherein each of the openings are bound by a tip of one of the primary pawls and an end wall of the pawl coupling base adjacent to the tip of the one of the primary pawls. In some embodiments, the ratchet member is an extra pawl coupled within a pivoting channel in the at least one of the lobes. In some embodiments, the ratchet member is a spring coupled within a holding cavity in the at least one of the lobes. In some embodiments, the ratchet member is a flexible protrusion formed by an extension of the at least one of the lobes. In some embodiments, the freehub assembly further comprises at least one biasing member that applies a biasing force to the plurality of primary pawls that resists the pivoting of the plurality of primary pawls away from the central axis of the freehub assembly. In some embodiments, the plurality of primary pawls are magnetic and the at least one biasing member is a plurality of magnets positioned within recesses within the pawl support member adjacent to the plurality of primary pawls. In some embodiments, the position of the recesses within the pawl support member is offset from a midline of the plurality of primary pawls such that the magnets provide a magnetic force biasing the plurality of primary pawls into the pawl coupling bases. In some embodiments, the biasing member is a spring that surrounds the plurality of primary pawls. In some embodiments, the lobes each include a flexible leaf spring that cushions contact between tips of the primary pawls and the lobes.

A second aspect is directed to a hub assembly. The hub assembly comprises a toothed ratchet gear, a freehub assembly including an outer hub sprocket attachment feature and a pawl support member, the pawl support member having a central axis, a plurality of pawl coupling bases and a plurality of primary pawls pivotably coupled to the pawl coupling bases along an are about the central axis and a pawl actuator assembly having an actuator body, a central hole extending through the actuator body and a plurality of lobes protruding from a perimeter of the actuator body away from the central hole, wherein at least one of the lobes includes a ratchet member that extends from the at least one lobe away from the central hole, wherein the plurality of primary pawls are positioned within the toothed ratchet gear, each lobe of the lobes of the pawl actuator assembly is positioned along the arc between two of the primary pawls, and when the toothed ratchet gear moves about the central axis in a first direction relative to the pawl actuator assembly, the ratchet member slidably contacts the toothed ratchet gear and the primary pawls do not contact the toothed ratchet gear.

In some embodiments, when the toothed ratchet gear rotates about the central axis in a second direction relative to the pawl actuator assembly, the ratchet member engages a tooth of the toothed ratchet gear such that the pawl actuator assembly begins to move with the toothed ratchet gear about the central aperture relative to the freehub assembly. In some embodiments, upon contacting the primary pawls when moving in the second direction, the lobes of the pawl actuator assembly cause the primary pawls to pivot away from the central axis until the primary pawls each engage a different tooth of the toothed ratchet gear. In some embodiments, the pawl support member has a plurality of openings along the arc having differing lengths, wherein each of the openings are bound by a tip of one of the primary pawls and an end wall of the pawl coupling base adjacent to the tip of the one of the primary pawls. In some embodiments, the ratchet member is an extra pawl coupled within a pivoting channel in the at least one of the lobes. In some embodiments, the ratchet member is a spring coupled within a holding cavity in the at least one of the lobes. In some embodiments, the ratchet member is a flexible protrusion formed by an extension of the at least one of the lobes. In some embodiments, the freehub assembly further comprises at least one biasing member that applies a biasing force to the plurality of primary pawls that resists the pivoting of the plurality of primary pawls away from the central axis of the freehub assembly. In some embodiments, the plurality of primary pawls are magnetic and the at least one biasing member is a plurality of magnets positioned within recesses within the pawl support member adjacent to the plurality of primary pawls. In some embodiments, the position of the recesses within the pawl support member is offset from a midline of the plurality of primary pawls such that the magnets provide a magnetic force biasing the plurality of primary pawls into the pawl coupling bases. In some embodiments, the biasing member is a spring that surrounds the plurality of primary pawls. In some embodiments, the lobes each include a flexible leaf spring that cushions contact between tips of the primary pawls and the lobes.

A third aspect is directed to a method of providing a hub system. The method comprises providing a toothed ratchet, providing a freehub assembly including an outer hub sprocket attachment feature and a pawl support member, the pawl support member having a central axis, a plurality of pawl coupling bases and a plurality of primary pawls pivotably coupled to the pawl coupling bases along an arc about the central axis, providing a pawl actuator assembly having an actuator body, a central hole extending through the actuator body and a plurality of lobes protruding from a perimeter of the actuator body away from the central hole, wherein at least one of the lobes includes a ratchet member that extends from the at least one lobe away from the central hole, coupling the freehub assembly with the toothed ratchet such that the plurality of primary pawls are positioned within the toothed ratchet gear and coupling the pawl actuator assembly with the freehub assembly such that each lobe of the lobes of the pawl actuator assembly is positioned along the arc between two of the primary pawls, wherein when the hub shell assembly moves about the central axis in a first direction relative to the pawl actuator assembly, the ratchet member slidably contacts the toothed ratchet gear and the primary pawls do not contact the toothed ratchet gear.

In some embodiments, when the hub shell assembly rotates about the central axis in a second direction relative to the pawl actuator assembly, the ratchet member engages a tooth of the toothed ratchet gear such that the pawl actuator assembly begins to move with the hub shell assembly about the central aperture relative to the freehub assembly. In some embodiments, upon contacting the primary pawls when moving in the second direction, the lobes of the pawl actuator assembly cause the primary pawls to pivot away from the central axis until the primary pawls each engage a different tooth of the toothed ratchet gear. In some embodiments, the pawl support member has a plurality of openings along the arc having differing lengths and each of the openings are bound by a tip of one of the primary pawls and an end wall of the pawl coupling base adjacent to the tip of the one of the primary pawls, the method further comprises adjusting a deadband of the hub by positioning the at least one of the lobes within the one of the openings having a length that corresponds to a desired deadband. In some embodiments, the ratchet member is an extra pawl coupled within a pivoting channel in the at least one of the lobes. In some embodiments, the ratchet member is a spring coupled within a holding cavity in the at least one of the lobes. In some embodiments, the ratchet member is a flexible protrusion formed by an extension of the at least one of the lobes. In some embodiments, the freehub assembly further comprises at least one biasing member that applies a biasing force to the plurality of primary pawls that resists the pivoting of the plurality of primary pawls away from the central axis of the freehub assembly. In some embodiments, the plurality of primary pawls are magnetic and the at least one biasing member is a plurality of magnets positioned within recesses within the pawl support member adjacent to the plurality of primary pawls. In some embodiments, the position of the recesses within the pawl support member is offset from a midline of the plurality of primary pawls such that the magnets provide a magnetic force biasing the plurality of primary pawls into the pawl coupling bases. In some embodiments, the biasing member is a spring that surrounds the plurality of primary pawls. In some embodiments, the lobes each include a flexible leaf spring that cushions contact between tips of the primary pawls and the lobes.

A fourth aspect is directed to a pawl actuator assembly for use in a hub. The assembly comprises an actuator body having an inner bore and a central hole extending through the actuator body for receiving an axle, a bearing positioned within the inner bore and about the central hole and a plurality of equidistant lobes protruding from a perimeter of the actuator body away from the central hole, wherein at least one of the lobes includes a ratchet member that extends from the at least one lobe away from the central hole.

A fifth aspect is directed to a hub system. The system comprises a wheel including a hub shell assembly, the hub shell assembly having a central aperture for receiving an axle, a driving face gear bore and a driving face radial gear having an inner cavity face with a set of driving teeth, wherein the driving face gear is positioned within the driving face gear bore, a freehub assembly including an outer hub sprocket attachment feature, an actuator face radial gear and a face gear support structure having a plurality of deadband grooves, wherein the actuator face gear has a first face including a plurality of actuator teeth and a second face having a plurality of deadband lobes positioned within the deadband grooves, wherein the actuator face radial gear is positioned within the driving face gear such that the plurality of actuator teeth contact the set of driving teeth, wherein when the hub shell assembly moves about the central aperture in a first direction relative to the freehub assembly, the actuator teeth slide past the driving teeth without engaging the driving teeth, and further wherein when the hub shell assembly moves about the central aperture in a second direction relative to the freehub assembly, the actuator teeth engage the driving teeth such that the hub shell assembly and the actuator face gear move together.

### BRIEF DESCRIPTION OF THE DRAWINGS

Several example embodiments are described with reference to the drawings, wherein like components are provided with like reference numerals. The example embodiments are intended to illustrate, but not to limit, the invention. The drawings include the following figures:

FIG. 1 illustrates a side view of a bicycle assembly according to some embodiments.

FIG. 2 illustrates a detailed view of a rear triangle of a bicycle assembly according to some embodiments.

FIG. 3 illustrates a perspective view of a hub assembly according to some embodiments.

FIG. 4 illustrates an exploded view of the hub assembly according to some embodiments.

FIG. 5 illustrates an exploded view of a hub shell assembly according to some embodiments.

FIG. 6 illustrates a cross-section view of the hub shell assembly along line A shown in FIG. 5 according to some embodiments.

FIG. 7 illustrates a perspective view of a freehub body assembly according to some embodiments.

FIG. 8 illustrates a partially exploded view of the freehub body assembly according to some embodiments.

FIG. 9 illustrates a perspective view of a freehub bearing assembly according to some embodiments.

FIG. 10 illustrates a side view of the freehub bearing assembly according to some embodiments.

FIG. 11 illustrates a perspective view of a pawl pusher according to some embodiments.

FIG. 12 illustrates a right end view of the pawl pusher according to some embodiments.

FIG. 13 illustrates a perspective view of a ratchet pawl according to some embodiments.

FIG. 14 illustrates an end view of the ratchet pawl according to some embodiments.

FIG. 15 illustrates a perspective view of a ratchet gear ring according to some embodiments.

FIG. 16 illustrates a side detail view of the ratchet gear ring according to some embodiments.

FIG. 17 illustrates a perspective view of a biasing element according to some embodiments.

FIG. 18 illustrates a perspective view of a deadband adjustment key according to some embodiments.

FIG. 19 illustrates a side cross-sectional view of a freehub bearing assembly including a coupled deadband adjustment key within a ratchet gear ring with the pawls retracted according to some embodiments.

FIG. 20 illustrates a side cross-sectional view of a freehub bearing assembly without a deadband adjustment key within a ratchet gear ring with the pawls retracted according to some embodiments.

FIG. 21 illustrates a side cross-sectional view of a freehub bearing assembly without a deadband adjustment key within a ratchet gear ring with the pawls extended according to some embodiments.

FIG. 22 illustrates a side cross-sectional view of a freehub bearing assembly including a coupled deadband adjustment key within a ratchet gear ring with the pawls extended according to some embodiments.

FIG. 23 illustrates a method of providing a hub assembly according to some embodiments.

FIG. 24 illustrates a perspective view of an alternate hub assembly according to some embodiments.

FIG. 25 illustrates a perspective exploded view of the hub assembly according to some embodiments.

FIG. 26 illustrates an exploded perspective view of the hub shell assembly according to some embodiments.

FIG. 27 illustrates a cross-section view of the hub shell assembly at section line B of FIG. 25 according to some embodiments.

FIG. 28 illustrates a perspective view of the freehub body assembly according to some embodiments.

FIG. 29 illustrates a partially exploded perspective view of the freehub body assembly according to some embodiments.

FIG. 30 illustrates a perspective view of the bearing assembly according to some embodiments.

FIG. 31 illustrates a side view of the bearing assembly according to some embodiments.

FIG. 32 illustrates a perspective view of the pawl actuator assembly according to some embodiments.

FIG. 33 illustrates a right side view of the pawl actuator assembly according to some embodiments.

FIG. 34 illustrates an exploded perspective view of the pawl actuator assembly according to some embodiments.

FIG. 35 illustrates a side view of the pusher ratchet pawl according to some embodiments.

FIG. 36 illustrates a perspective view of the pawl pusher body according to some embodiments.

FIG. 37 illustrates a left side view of the pawl pusher body according to some embodiments.

FIG. 38 illustrates a right-side section view of the pawl pusher body at section line C of FIG. 36 according to some embodiments.

FIG. 39 illustrates a perspective view of the biasing element according to some embodiments.

FIG. 40 illustrates a perspective view of a primary pawl according to some embodiments.

FIG. 41 illustrates an end view of a primary pawl according to some embodiments.

FIG. 42 illustrates a perspective view of the toothed ratchet gear according to some embodiments.

FIG. 43 illustrates a cutout side view of the toothed ratchet gear in the cutout D shown in FIG. 42 according to some embodiments.

FIG. 44 illustrates a left side section view of the pawl actuator assembly, freehub body assembly and ratchet ring of the hub assembly at section line A of FIG. 24 according to some embodiments.

FIG. 45 illustrates a left side section view of the pawl actuator assembly, freehub body assembly and ratchet ring of the hub assembly at section line A of FIG. 24 according to some embodiments.

FIG. 46 illustrates a left side section view of the pawl actuator assembly, freehub body assembly and ratchet ring of the hub assembly at section line A of FIG. 24 according to some embodiments.

FIG. 47 illustrates a left side section view of the pawl actuator assembly, freehub body assembly and ratchet ring of the hub assembly at section line A of FIG. 24 according to some embodiments.

FIG. 48 is a partial detail section view at circle cutout E of FIG. 46 according to some embodiments.

FIG. 49 illustrates a left side view of an alternative actuator assembly according to some embodiments.

FIG. 50 illustrates an exploded perspective view of an alternative actuator assembly according to some embodiments.

FIG. 51 illustrates a left side view of a second alternative actuator assembly according to some embodiments.

FIG. 52 illustrates a perspective view of a magnetic freehub assembly according to some embodiments.

FIG. 53 illustrates an exploded perspective view of a magnetic freehub assembly according to some embodiments.

FIG. 54 illustrates a rear view of a magnetic freehub assembly according to some embodiments.

FIG. 55 illustrates a left side section view of the magnetic freehub assembly at section line C of FIG. 54 according to some embodiments.

FIG. 56 illustrates a right side section view of a face gear hub assembly at section line D in FIG. 57 according to some embodiments.

FIG. 57 illustrates an exploded perspective view of a face gear freehub assembly according to some embodiments.

FIG. 58 illustrates a perspective view of the actuator face gear according to some embodiments.

FIG. 59 illustrates a perspective view of the shell driving face gear according to some embodiments.

FIG. 60 illustrates a section view of the face gear freehub assembly at section line C in FIG. 56 in the freewheeling orientation showing face gear deadband angle B1 according to some embodiments.

FIG. 61 illustrates a section view of the face gear freehub assembly at section line C in FIG. 56 in the torque transmitting orientation according to some embodiments.

FIG. 62 illustrates a method of providing a bicycle hub system according to some embodiments.

FIG. 63 illustrates a method of providing a bicycle hub system according to some embodiments.

### DETAILED DESCRIPTION OF THE EMBODIMENTS:

Embodiments of the application are directed to a freewheel hub having a non-zero and/or invariant deadband distance (in addition to the inherent linear variable deadband attributable to the hub ratchet mechanism) in order to reduce or eliminate pedal kickback. This allows the freehub body to always move through a prescribed free motion before hub engagement, regardless of the relative position of the freehub body and the hub shell, and regardless of the number of teeth in the freehub ratchet mechanism. In other words, it sets the lowest value for deadband motion to a repeatable, positive amount, rather than zero. The deadband distance is able to have and/or be adjusted to a desired length by adjusting a deadband gap inside the hub.

Reference will now be made in detail to implementations of a bicycle and/or freewheel hub, such as illustrated in the accompanying drawings. The same reference indicators will be used throughout the drawings and the following detailed description to refer to the same or like parts. In the interest of clarity, not all of the routine features of the implementations described herein are shown and described. It will be appreciated that in the development of any such actual implementation, numerous implementation-specific decisions can be made in order to achieve the developer's specific goals, such as compliance with application and business related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

FIG. 1 illustrates a bicycle assembly 200 according to some embodiments. As shown in FIG. 1, the bicycle assembly 200 comprises a bicycle rear wheel 202 (including a hub assembly 1), a bicycle front triangle 204 and a bicycle rear triangle 206 coupled with the front triangle 204. The bicycle front triangle 204 and bicycle rear triangle 206 are coupled together via a bicycle suspension link 216, which compresses a bicycle rear shock absorber 210 that is coupled between the front triangle 204 and the suspension link 216. The assembly 200 further comprises a bicycle crank 208 operably coupled with a bicycle chainring 209 engaged with a bicycle chain 212. A bicycle cassette 214 is mounted to the bicycle rear wheel 202, which is engaged to said bicycle chain 212. A bicycle rear derailleur 215 is engaged to said chain 212 and mounted to said rear triangle 206 proximate said rear wheel 202. Alternatively, one or more of the above components are able to be omitted. Further, although only the components above are described in detail, it is understood that the bicycle assembly 200 is able to comprise one or more other components well known in the art that are not described herein for the sake of brevity.

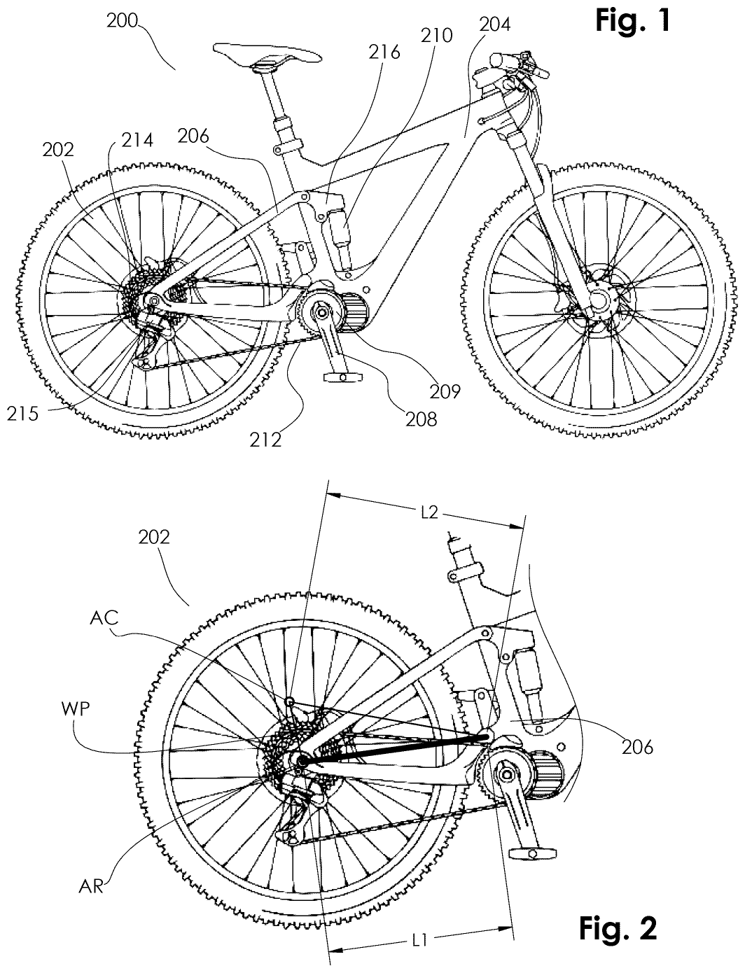

FIG. 2 illustrates a detailed view of the bicycle rear triangle 206 and bicycle rear wheel 202 according to some embodiments. As shown in FIG. 2, overlaid geometry shows the Axle Position Resting AR, Axle Position Compressed AC, Wheel Path WP, Bicycle Chainstay Length L1 and Bicycle Chainstay Length L2. In particular, this geometry is overlaid to demonstrate the change to the bicycle frame geometry under suspension compression. When not under significant compression, the axle is at position AR and the chainstay length is equal to L1. When under compression, the axle moves along path WP to position AC thereby increasing the chainstay length to L2. As described above, this increase in chainstay length can abruptly rotate the freewheel body with respect to the freewheel shell and thereby cause pedal kickback if the deadband is zero or minimal.

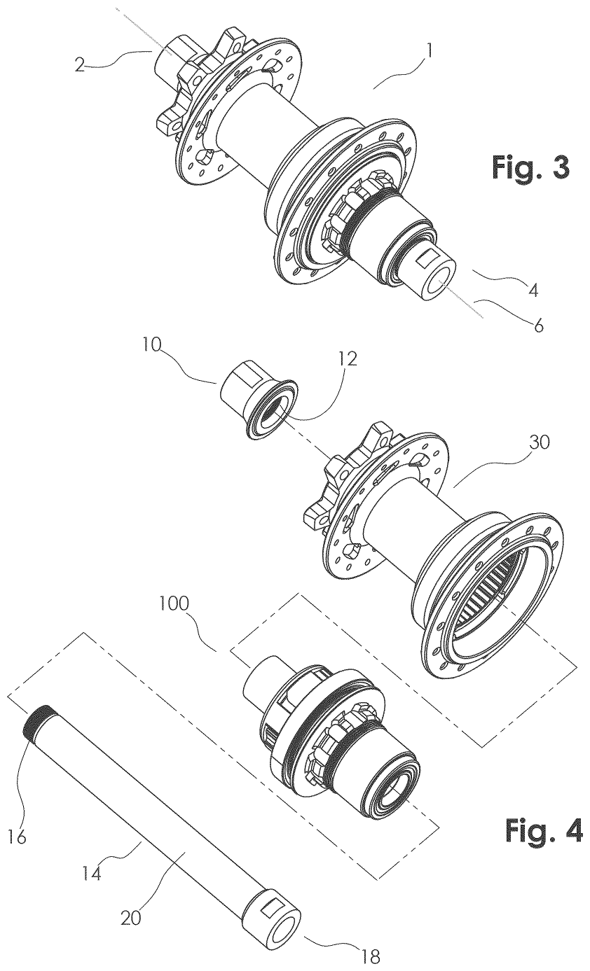

FIG. 3 illustrates a perspective view of the hub assembly 1 according to some embodiments. As shown in FIG. 3, the hub assembly 1 comprises first end 2, second end 4, and hub central axis 6. FIG. 4 illustrates a perspective exploded view of the hub assembly 1 according to some embodiments. As shown in FIG. 4, the hub assembly comprises a hub shell assembly 30, a freehub body assembly 100, a hub axle 14 and a hub axle cap 10. Both the hub shell assembly 30 and the freehub body assembly 100 are able to slide onto the hub axle 14 such that they are located on a hub axle bearing surface 20. The hub axle cap 10 is able to be threaded onto said axle 14 with a hub axle cap thread 12 threading onto a hub axle thread 16, such that the hub axle right end 18 is opposite said end cap 10 with the assemblies 30, 100 in between.

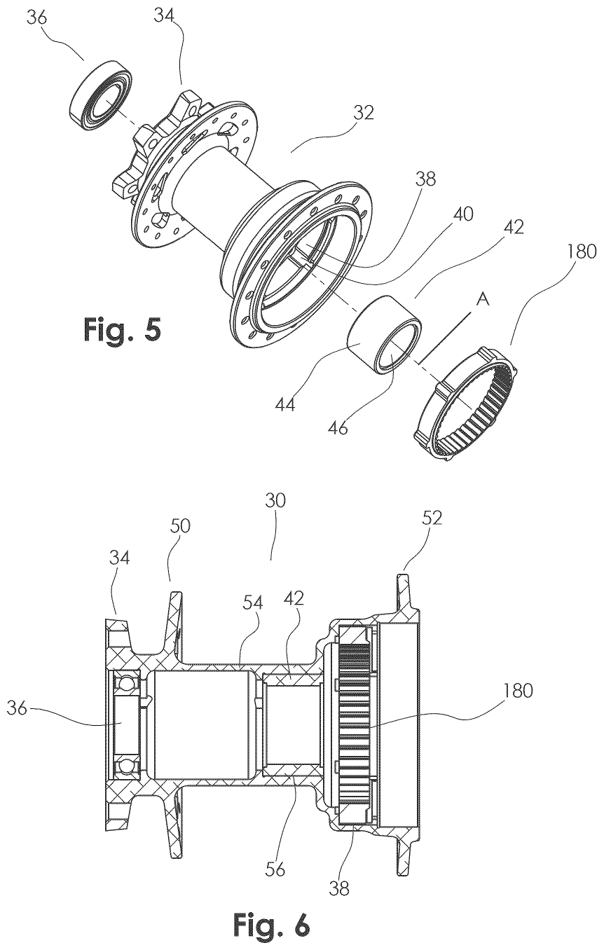

FIG. 5 illustrates an exploded perspective view of the hub shell assembly 30 according to some embodiments. As shown in FIG. 5, the hub shell assembly 30 comprises a hub shell 32, a hub shell disc flange 34, a hub shell bearing 36, a hub shell ratchet gear bore 38, one or more hub shell ratchet gear spline slots 40, a one-way clutch 42 having an outer race 44 and an inner bore 46, and a toothed ratchet gear 180. In some embodiments, the one-way clutch is a sprag clutch. Alternatively, the one-way clutch 42 is able to be other types of over-running or one-way clutches, including but not limited to a roller clutch, a pawl clutch, a wound-spring type clutch, a face-gear clutch, and/or other similar clutches. Some of these clutches would not allow for silent hub operation, but they would allow for the same adjustable deadband operation of the hub 1.

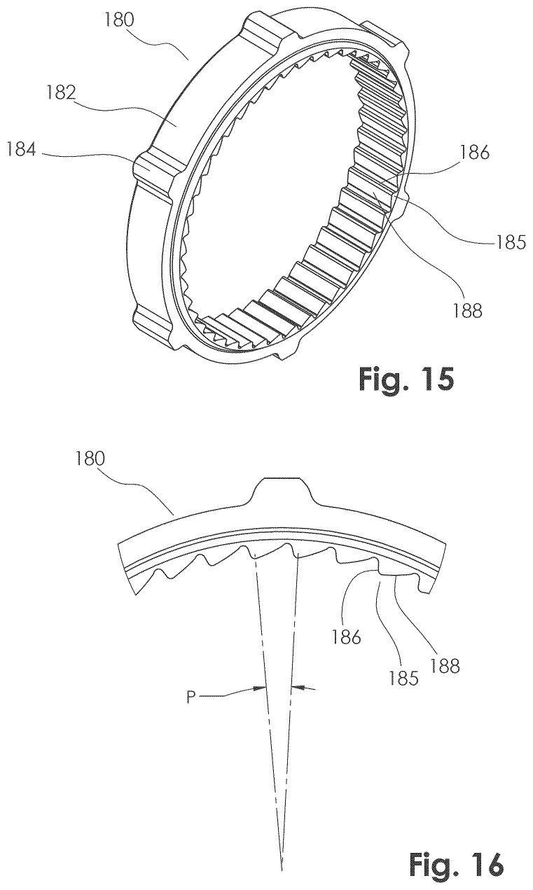

FIG. 6 illustrates a cross-section view of the hub shell assembly 30 at section line according to some embodiments. As shown in FIG. 6, the hub shell 32 comprises a hub shell body 54, hub shell disc flange 34 (e.g. for coupling with a brake rotor), hub shell left spoke flange 50 and hub shell right spoke flange 52 (e.g. both for coupling with one or more spokes (not shown)). Further, as shown in FIG. 6, the hub shell bearing 36 is able to be positioned within a bearing cavity within the flange 34 (e.g. for receiving axle 14), the one-way clutch 42 is able to be fitted into hub shell clutch bore 56 (e.g. for receiving the stem 142 of the pusher 140, and the ratchet gear 180 is able to be positioned within the hub shell ratchet bore 38. In particular, when positioned within the hub shell ratchet bore 38, each of a plurality of ratchet ring spline teeth 184 (see FIG. 15) of the ratchet ring 180 extend into a different one of the hub shell ratchet spline slots 40. As a result, when the ratchet ring 180 is rotated, the ratchet ring spline teeth 184 apply a force to the ratchet spline slots 40 thereby causing the hub shell 32 to similarly rotate. Additionally, the outer surface of the stem 142 of the pusher 140 is able to contact the inner bore 46 of the one-way clutch 42 such that the inner bore 46 rotates with the pusher 140 in a first direction of rotation, but resists and/or stops rotation of the pusher 140 in the opposite direction (e.g. via friction between the outer surface of the stem 142 and the inner bore 46).

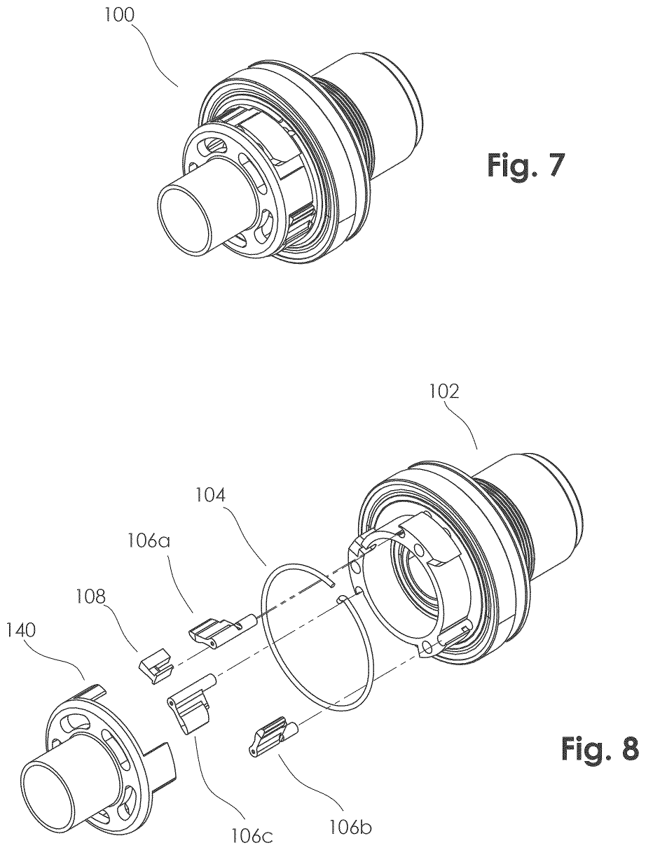

FIGS. 7 and 8 illustrates perspective and partially exploded perspective views, respectively, of the freehub body assembly 100 according to some embodiments. As shown in FIGS. 7 and 8, the freehub body assembly 100 comprises a bearing assembly (or pawl support member) 102, a pawl pusher 140, a deadband adjustment key 108, one or more ratchet pawls 106a-c, and a pawl biasing element 104. In some embodiments, the biasing element 104 is a wire spring. Alternatively, the biasing element 104 is able to be other types of biasing elements including, but not limited to, one or a combination of one or more leaf springs, one or more coil springs, one or more rubber bands, one or more magnets (e.g. placed in the freehub body under steel pawls 106), and/or any other kind of spring loading mechanism.

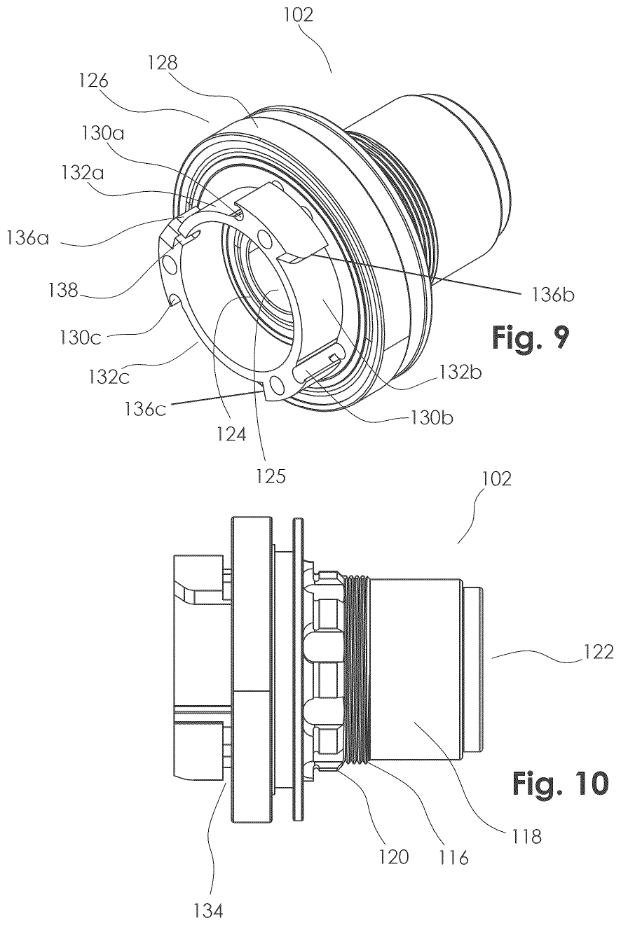

FIGS. 9 and 10 illustrate perspective and side views, respectively, of the bearing assembly 102 according to some embodiments. As shown in FIGS. 9 and 10, the bearing assembly 102 comprises a freehub end bearing 122 (e.g. for receiving the axle 14), a freehub external bearing 126 with an external bearing outer race 128, a freehub internal bearing 124 with an internal bearing inner race 125 (e.g. for receiving the axle 14), a cassette spline 120, a cassette mounting thread 116, a cassette mounting boss 118, a biasing element slot 134, one or more pawl cylinder slots 130a-c, one or more deadband surfaces 132a-c, one or more pusher stop surfaces 136a-c, and a deadband adjustment key slot 138. The cassette spline 120 and/or cassette mounting boss 118 is able to receive a splined cassette (not shown) in order to coupled with a drive assembly of the bicycle 200 (e.g. the bicycle crank 208, the bicycle chainring 209, the bicycle chain 212, the derailleur 215 and/or other components). A cassette locking bolt (not shown) is able to threadably couple to the cassette mounting thread 116 to secure the cassette onto the spline 120. Although as shown in FIGS. 9 and 10, the bearing assembly 102 comprises three pawl cylinder slots 130a-c, deadband surfaces 132a-c and pusher stop surfaces 136a-c, and a single deadband reducer slot 138, more or less pawl cylinder slots 130a-c, deadband surfaces 132a-c, pusher stop surfaces 136a-c, and deadband reducer slots 138 are contemplated.

Similarly, although as shown in FIGS. 7 and 8, the freehub body assembly 100 comprises a pawl pusher 140 having three fingers 144, a single deadband adjustment key 108, three ratchet pawls 106a-c and a single pawl biasing element 104, a pawl pusher 140 having more or less fingers 144, more or less deadband adjustment keys 108, more or less ratchet pawls 106a-c and/or more or less pawl biasing elements 104 are contemplated. In particular, the number of deadband adjustment keys 108 is able to correspond to the number of deadband adjustment key slots 138, and the number of fingers 144, cylinder slots 130a-c, deadband surfaces 132a-c and stop surfaces 136a-c is able to correspond to the number of pawls 106a-c. The space defined between each of the pawl cylinder slots 130a-c, the corresponding stop surface 136a-c and the corresponding deadband surface 132a-c, is able to form a plurality of deadband cavities that are filled by the fingers 144 of the pusher 140, the pawls 106a-c (at least in a fully retracted position) and the deadband adjustment key 108 (when coupled within the deadband adjustment key slot 138).

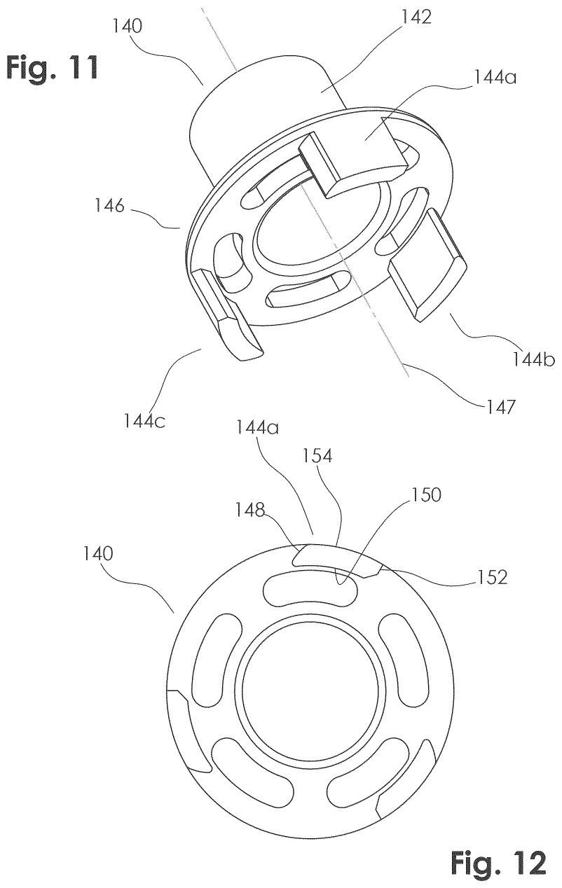

FIGS. 11 and 12 illustrate perspective and front views, respectively, of the pawl pusher 140 according to some embodiments. As shown in FIGS. 11 and 12, the pawl pusher 140 comprises a central cavity 147 (for receiving the axle 14), a stem or clutch cylinder 142, a finger flange 146 and one or more pawl fingers 144a-c. Each of the fingers 144 comprise finger pawl surface 148, finger outside diameter 154, finger locating cylinder 150, and pusher freewheel stop 152. In operation, the locating cylinder 150 of the pawl fingers 144 is able to slide along the deadband surface 132a-c within the deadband cavities between the pawls 106a-c and the stop walls 136a-c or an inserted key 108. As a result, the pawl surface 148 is able to slide under the pawl pusher cam surface 166 (see FIG. 14) in order to cause the pawls 106a-c to pivot from the retracted position to the extended position. When slide in the opposite direction, the pusher freewheel stop 152 is able to contact the stop walls 136a-c and/or the inserted key 108 (thereby defining the deadband distance).

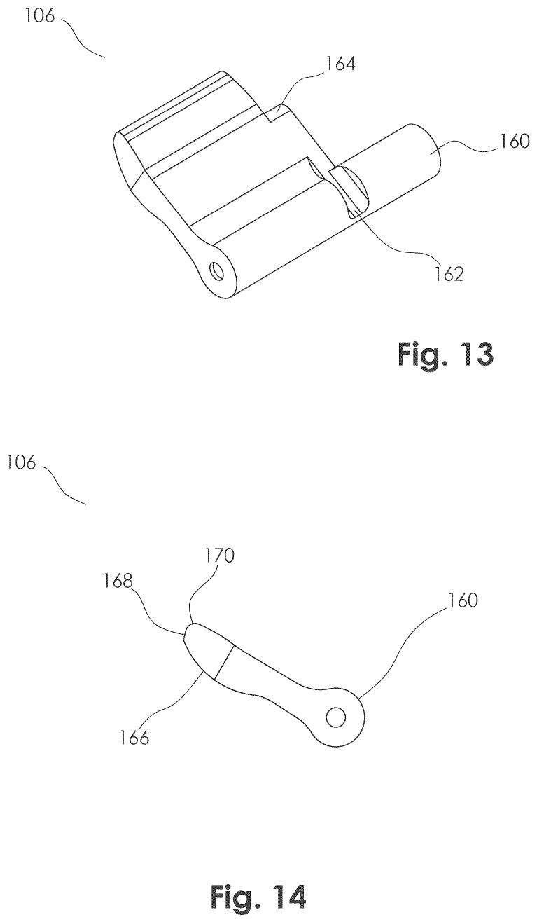

FIGS. 13 and 14 illustrate perspective and end views, respectively, of a ratchet pawl 106a-c according to some embodiments. As shown in FIGS. 13 and 14, the ratchet pawl 106a-c comprises a pawl cylinder 160, a pawl biasing element groove 162, a pawl spring pad 164, a pawl pusher cam surface 166, a pawl driving surface 168 and a pawl tip radius 170. The pawl pusher cam surface 166 is for sliding over the pusher fingers 144 as described above. The pawl driving surface 168 is configured to engage the ratchet tooth receiving face 186 and/or the pawl tip radius 170 is configured to fit within the valleys between the teeth 185 of the ratchet gear 180 (thereby engaging and causing the gear 180 to rotate with the freehub assembly 100).

The pawl cylinder 160 of each of the pawls 106a-c is able to slidably fit within one of the pawl cylinder slots 130a-c. When positioned within one of the slots 130a-c, the pawls 106a-c are able to pivot about a central axis of the slot 130 between a retracted position adjacent to the respective deadband surface 132a-c and an extended position away from the deadband surface 132a-c. The biasing element 104 is able to fit withing the gap 134 (see FIG. 10) at least partially surrounding or blocking the pivoting of pawls 106a-c away from the deadband surface 132a-c. In particular, the biasing element 104 is able to be positioned within the pawl biasing element groove 162 and adjacent to or around the pawl spring pad 164 of each of the pawls 106a-c in order to resist the pivoting away from the deadband surface 132a-c and/or bias the pawls 106a-c in the retracted position. Indeed, by providing a shortened pad 164, the pawls 106a-c enable the biasing element 104 to have a smaller diameter and/or size and be closer to the deadband surface 132a-c.

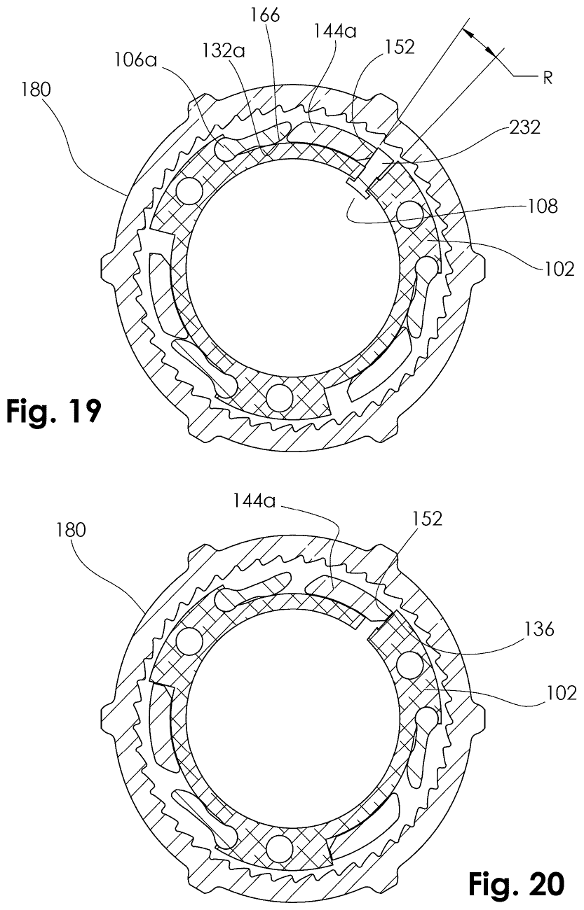

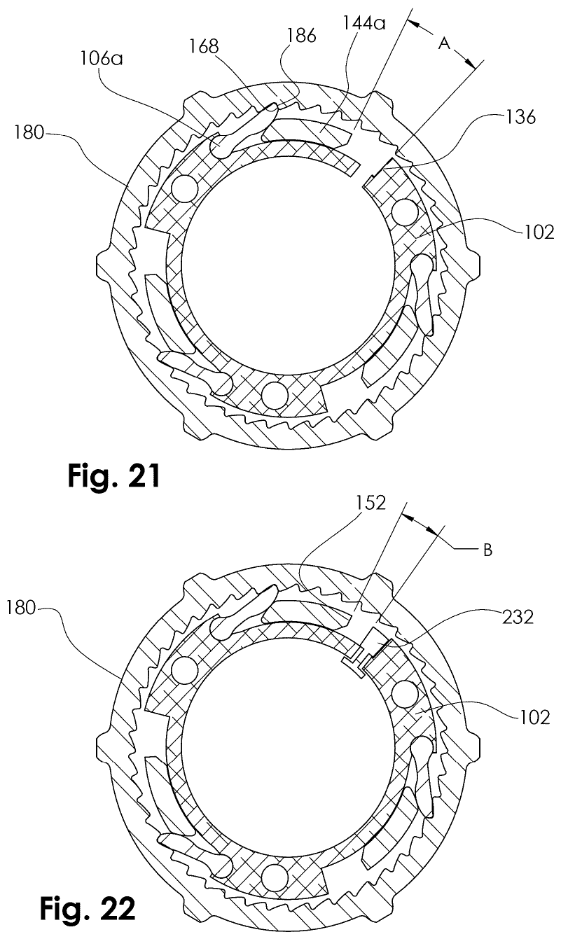

When in the extended position (see FIGS. 21 and 22), the pawls 106a-c are pivoted away from the deadband surface 132a-c such that they are able to engage the teeth 185 of the ratchet gear 180 (e.g. contact a ratchet tooth receiving face 186 and/or a bottom of the valley between teeth 185). In some embodiments, when in the retracted position the pawls 106a-c are able to contact the deadband surface 132a-c and/or be positioned fully within the corresponding deadband cavity (e.g. when the corresponding pusher finger 144 is able to slide to be adjacent to a stop wall 136a-c or able to slide to be adjacent to the inserted key 108, but still does not impede or block the pivoting of the corresponding pawl 106a-c (see FIGS. 19 and 20)). Alternatively, when in the retracted position the pawls 106a-c are able to be at least partially blocked from contacting the deadband surface 132a-c and/or from being positioned fully within the corresponding deadband cavity (e.g. when despite being fully slide against an inserted key 108, the corresponding pusher finger 144 impedes or blocks the pivoting of the corresponding pawl 106a-c toward the deadband surface 132a-c). In particular, by inserting and/or selecting a size of the key 108, a user is able to adjust the retracted position by adjusting how close the fingers 144 are to the pawls 106a-c and/or the extent that the fingers 144 block the inward pivoting of the pawls 106a-c.

FIGS. 15 and 16 illustrate perspective and detail views, respectively, of the toothed ratchet gear 180 according to some embodiments. As shown in FIG. 15, the toothed ratchet gear 180 comprises a ring-shaped body having an outside surface 182, one or more outer splines 184 protruding from the outside surface 182 of the body, and a plurality of inner teeth 185 protruding from an inner surface of the body. Each of the inner teeth 185 have a ratchet tooth receiving face 186 and a ratchet tooth sliding face 188 with a valley formed where the sliding face 188 of each tooth meets the receiving face 186 of the adjacent tooth 185. A ratchet tooth pitch angle P is shown as the angle between two adjacent teeth 185. The sliding face 188 is able to be longer and/or make a smaller angle with respect to the adjacent inner surface of the body than the receiving face 186. Additionally, the shape, contour and/or size of the pawl driving surface 168 and the pawl tip radius 170 of each of the pawls 106a-c is able to compliment the shape of the valleys and/or curvature of the sliding face 188.

As a result, when the pawls 106a-c are extended such that they contact the teeth 185 and moved/rotated in a direction from the valley in between teeth 185 along the adjacent sliding face 188, the smaller angle enables the pawls 106a-c to slide over the teeth 185 without engaging the teeth 185. In contrast, when moved/rotated in the opposite direction from the valley in between teeth 185 along the adjacent receiving face 186, the larger/steeper angle causes the pawl driving surface 168 and/or the pawl tip radius 170 to catch against the receiving face 186 and/or within the valleys thereby engaging the teeth 185 and forcing the ring to rotate in the same direction as the pawls 106a-c. Alternatively, the sliding and receiving faces 186, 188 are able to be the same length and/or angle.

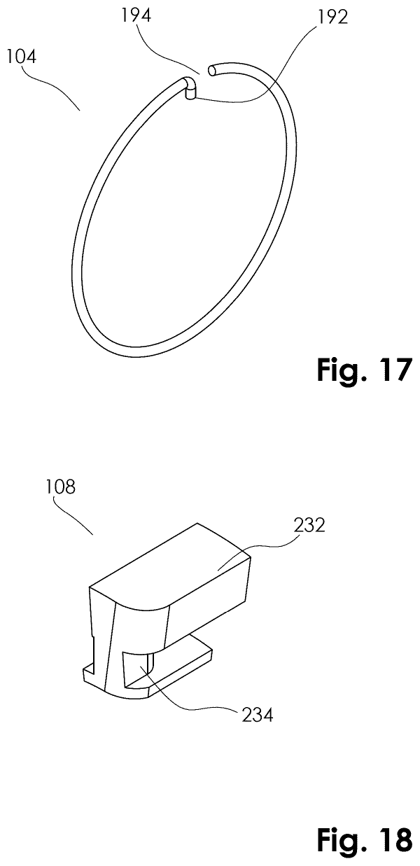

FIG. 17 illustrates a perspective view of the biasing element 104 according to some embodiments. As shown in FIG. 17, the biasing element 19 comprises an elongated body shaped to surround each of the pawls 106a-c, the body having a gap 194 enabling the body to flex to fit around the pawls 106a-c before springing back to shape, and a tang 192 to catch on one or more of the pawls 106a-c and thereby prevent the biasing element 104 from rotating with respect to the pawls 106a-c. The biasing element 104 is able to comprise a flexible material or combination of materials including, but not limited to, rubber, metal, plastic or other flexible material known in the art. As described above, the biasing element 104 is able to fit withing the gap 134 (see FIG. 10) at least partially surrounding or blocking the pivoting of pawls 106a-c away from the deadband surface 132a-c. In particular, the biasing element 104 is able to be positioned within the pawl biasing element groove 162 and adjacent to or around the pawl spring pad 164 of each of the pawls 106a-c in order to resist the pivoting away from the deadband surface 132a-c and/or bias the pawls 106a-c in the retracted position. Indeed, by providing a shortened pad 164, the pawls 106a-c enable the biasing element 104 to have a smaller diameter and/or size and be closer to the deadband surface 132a-c. Additionally, the pad 164 provides a surface for the tang 192 to catch/grip and thereby prevent the biasing element 104 from rotating with respect to the pawls 106a-c.

FIG. 18 illustrates a perspective view of the deadband adjustment key 108 according to some embodiments. As shown in FIG. 18, the deadband adjustment key 108 comprises an adjustment block 232 and a coupling member 234. The coupling member 234 is able to have a trunk configured to fit within the deadband adjustment key slot 138 and a holding sheet that extends below an inside of the slot thereby keeping the trunk/key from falling out of the slot 138. The adjustment block 232 is able to extend from the slot 138 into the adjacent deadband recess next to the stop wall 136 of that recess (see FIGS. 19 and 22). As a result, when inserted into the slot 138, the adjustment block 232 reduces the size of the deadband recess by reducing the maximum distance that the pusher finger 144 of that recess (and all the other pusher fingers 144 because they are coupled together) is able to slide away from the pawl 106a-c of that recess. Indeed, although FIG. 18 illustrates an adjustment block 232 having a first width (e.g. width R shown in FIG. 19), it is understood that the adjustment block 232 is able to have larger or smaller widths and/or that the system is able to include multiple keys 108 having blocks 232 of different widths such that the user is able to select a key 108 having a desired width as a manner of adjusting the deadband distance of the system. Alternatively, the bearing assembly 102 is able to have a plurality of slots 138 along one of the deadband recesses such that deadband distance is able to be adjusted by inserting the key 108 in one of the slots 138 that is a desired distance from the stop wall 136 and/or pawl 106a-c of that recess.

FIG. 19 is a section view of hub assembly 1 with the freehub body assembly 100 inserted (e.g. concentrically nested) within the toothed ratchet gear 180 according to some embodiments. As shown in FIG. 19, the pawls 106a-c are in the retracted position (e.g. due to the force applied by the biasing element 104) with the block 232 of the inserted deadband adjustment key 108 reducing the distance between the pawls 106a-c and the fingers 144a-c. As a result, the hub assembly 1 is in a freewheeling configuration where the hub shell assembly 30 (e.g. the gear 180) is able to rotate clockwise with respect to the freehub body assembly 100 (e.g. the pawls 106a-c). Indeed, because the pawls 106a-c are able to retract such that they do not contact the gear 180, the hub assembly 1 is in a silent freewheeling configuration where the hub assembly 1 does not make a clicking noise found in traditional assemblies due to the contact of the pawls 106a-c with the gear 180. As shown in FIG. 19, in this configuration the pawl 106a is positioned so that the pawl pusher cam surface 166 is in contact with the deadband surface 132a and/or within the deadband cavity. Further, the pusher freewheel stop 152 is in contact with the block 232, therefore the deadband reduction angle R is developed between said pusher freewheel stop 152 and the stop surface 136.

FIG. 20 is another section view of hub assembly 1 with the freehub body assembly 100 inserted (e.g. concentrically nested) within the toothed ratchet gear 180 according to some embodiments. However, unlike FIG. 19, in FIG. 20 the key 108 is not inserted in the slot 138 such that the deadband distance remains at its maximum. In particular, the pawls 106a-c are in the retracted position (e.g. due to the force applied by the biasing element 104) with the fingers 144a-c slid against the stop walls 136 away from the pawls 106a-c. As a result, the hub assembly 1 is in again in a silent freewheeling configuration where the hub shell assembly 30 (e.g. the gear 180) is able to rotate clockwise with respect to the freehub body assembly 100 (e.g. the pawls 106a-c). However, unlike the configuration in FIG. 19, the longer deadband distance in FIG. 20 will increase the time required for the fingers 144a-c to push the pawls 106a-c to the extended position and thus increase the time required for the pawls 106a-c to engage the gear 180 thereby reducing the likelihood of pedal kickback.

FIG. 21 is another section view of hub assembly 1 with the freehub body assembly 100 inserted (e.g. concentrically nested) within the toothed ratchet gear 180 according to some embodiments. As shown in FIG. 21, the pawls 106a-c are in the extended position due to the extending force applied to the pawls 106a-c by the fingers 144a-c overcoming the biasing force applied by the biasing element 104. In particular, as the freehub body assembly 100 begins to rotate clockwise (e.g. due to pedaling), the one-way clutch 42 provides a drag or stopping force to the stem 142 of the pusher 140 such that the fingers 144a-c move counterclockwise with respect to the pawls 106a-c (and the remainder of the assembly 100). As a result, the fingers 144a-c slide along the deadband surface 132a-c toward the pawls 106a-c and eventually contact the pawls 106a-c, sliding under the tip 168 and the surface 166 thereby causing the pawls 106a-c to pivot away from the deadband surface 132a-c toward the teeth 185 of the ratchet gear 180 and into the extended position. When in the extended position, the pawls 106a-c contact/engage the teeth 185 of the ratchet gear 180 so that pedaling torque applied to the freehub body assembly 100 is transferred to the hub shell assembly 30 via the pawls 106a-c pressing against the teeth 185 of the ratchet gear 180 (which presses against the hub shell assembly 30). In this extended position, the ratchet pawls 106a-c are positioned so that pawl driving surface 168 is pressing against ratchet tooth receiving face 186. Engagement deadband angle/length A is shown as the free movement of the fingers 144a-c of the pawl pusher 140 before the ratchet pawl 106a is in complete contact with ratchet gear 180. Indeed, because the key 108 is not inserted in the key slot 138, the pawl pushers 140 must move the maximum deadband distance in order to cause the pawls 106a-c to fully extend and/or engage the ratchet gear 180.

As described above, when transitioning from the extended position to the retracted position, as they move counterclockwise with respect to the gear 180, the pawls 106a-c slide against the sliding face 188 of the teeth 185 without engaging the teeth 185 thereby enabling the gear 180 to rotate clockwise independent of the freehub body assembly 100. In contrast, when transitioning from the retracted position to the extended position, as they move clockwise with respect to the gear 180, once the pawls 106a-c pivot such that they are able to contact the gear 180, the pawls 106a-c catch/engage with one of the receiving faces 186 of the teeth 186 thereby causing the gear 180 to rotate clockwise due to the force of the clockwise rotation of the freehub body assembly 100.

FIG. 22 is another section view of hub assembly 1 with the freehub body assembly 100 inserted (e.g. concentrically nested) within the toothed ratchet gear 180 according to some embodiments. In particular, FIG. 22 is substantially similar to FIG. 21 except that the deadband adjustment key 108 is inserted into the key slot 138 thereby reducing the deadband distance. As a result, as illustrated by the reduced length B, instead of moving the longer length/angle A as shown in FIG. 21, the pawl pushers 140 only need to move the less than maximum deadband distance/angle B in order to cause the pawls 106a-c to fully extend and/or engage the ratchet gear 180. Thus, the hub assembly 1 provides the advantage of enabling the deadband distance to be adjusted and/or configured for silent freewheeling. In particular, the combination of the biasing element 104 causing the pawls 106a-c to automatically retract into the retracted position and the one-way ratchet 42 and/or pusher 140 causing the pawls 106a-c to extend when the assembly 100 is rotated in a drive direction (e.g. clockwise) enable the assembly to be customized to reduce pedal kickback and/or to a responsiveness level desired by the rider.

In operation, as described above the hub 1 is able to operate in two modes. In the first mode, “freewheeling,” the hub 1 freewheels when the bicycle 200 is rolling forward and the pedal crank 208 remains stationary. The cranks 208, chain 212, cassette 214 and freehub body assembly 100 remain motionless relative to the bicycle frame 204, 206, while the rear wheel rotates forward. In the second mode, the hub 1 drives the bicycle 200 forward when the pedal cranks 208 are pedaled forward by the bicycle rider. The chainring 209 rotates and applies tension to the bicycle chain 212, rotating the bicycle cassette 214 and freehub body assembly 100, and the freehub body assembly 100 applies torque to the hub shell assembly 30, rotating the wheel and driving the bicycle 200 forward. In this manner the rider propels the bicycle 200 forward by rotating the pedals.

In further detail, as described above, the hub assembly 1 freewheels when the ratchet pawls 106a-c are in the retracted position towards the bearing assembly 102, as depicted in FIG. 19. Under freewheeling conditions, the hub shell assembly 30 rotates clockwise relative to the hub center axis 6, while the freehub body assembly 100 remains stationary. The one-way clutch 42 is therefore also rotating clockwise relative to the pusher stem 142. The one-way clutch 42 is able to be specified and installed such that it allows the pusher stem 142 to rotate freely in the drive (e.g. forward pedaling or clockwise direction), but locks and resists or stops rotation in the opposite direction (e.g. counter-clockwise direction). Thus, as the hub shell assembly 30 freewheels, the residual drag in the clutch 42, which owing to the physics of any free-running clutch cannot be zero, is able to continuously rotate the pawl pusher 140 clockwise relative to the pawl pusher center axis 147, which is nominally identical to the hub center axis 6.

During freewheeling, the biasing element 104 contacts the pawl pads 164 and presses the pawls 106a-c inward towards the center of the hub 100, allowing the ratchet gear 180 to rotate freely around the ratchet pawls 106a-c with no contact, and consequently no sound. In particular, as described above, the biasing element 104 is able to be sized such that it provides a constant inward force towards the hub center axis 6 on the pawl spring pads 164 throughout the entire free range of the pawls 106a-c within the assembly 1. This force may be controlled by sizing the resting diameter of the shape of the elongated body of the biasing element 104, by choosing the strength/flexibility of the material of the biasing element 104 and/or the diameter of the body of the biasing element 104.

Depending on how the hub deadband distance has been configured, the pusher stop wall 152 is able to be pressed against either the freehub stop surface 136 or the deadband adjustment key block 232 (if the deadband adjustment key 108 is installed in the hub 100). If the deadband adjustment key 108 is not installed, the parts of the hub will be resting in the configuration shown in FIG. 20. If the deadband adjustment key 108 is installed, the parts will be resting in the configuration shown in FIG. 19.

The deadband of the hub 1 is developed as the rider transitions from coasting to moving the pedal cranks 208 and actively pedaling the bicycle 200 forward. As the pedal cranks 208 begin moving, the freehub bearing assembly 102 begins rotating clockwise relative to the hub center axis 6, until the speed of the freehub bearing assembly 102 matches the rolling speed of the hub shell assembly 30. Once these rotational velocities match, the pusher stem 142 is stationary relative to the one-way clutch 42, and therefor as the one-way clutch 42 begins to develop a torque against the pusher stem 142, and thus the pawl pusher 140 begins to rotates in the opposing direction (e.g. counter-clockwise) relative to the freehub bearing assembly 102. As this rotation occurs, the pusher cam surface 166 of the pawls 106a-c moves towards and comes into contact with the pawl surface 148 of the pusher fingers 144a-c. Once this happens the ratchet pawls 106a-c begin to pivot about the pawl cylinder 160, such that the pawl tip radius 170 moves outward towards the ratchet gear 180. Since the ratchet gear 180 may still be rotating relative to the freehub bearing assembly 102, the pawl tip radius 170 contacts the ratchet gear 180 in a random location based on when the pedal stroke is started, the speed of the wheel, and other factors. Once this contact occurs, the pawl tip radius 170 slides over the ratchet tooth sliding face 188 until the pawl driving surface 168 contacts the ratchet tooth receiving face 186. Once this contact occurs, torque is transferred from the freehub bearing assembly 102 to the hub shell assembly 30 via the ratchet pawls 106a-c in compression against the teeth 185.

Once underway, the rider may cease pedaling to resume freewheeling. When torque is no longer applied to the freehub bearing assembly 102, the ratchet gear 180 resumes (e.g. clockwise) rotation relative to the freehub bearing assembly 102, and the ratchet pawl 106 is forced away from the ratchet ring 180 as the pawl tip radius 170 slides back down the ratchet tooth sliding face 188 (and/or due to the inward biasing force applied by the biasing element 104). Simultaneously, the pawl pusher 140 is free to rotate (e.g. clockwise) with the hub shell assembly 30, and is able to be helped along by the sliding contact between the pawl surface 148 of the pusher 140 and the pusher cam surface 166 of the pawls 106a-c. Once the ratchet pawls 106a-c have moved to the retracted position, the pawl pusher 140 continues rotating clockwise relative to the freehub bearing assembly 102 owing to the parasitic free-running drag between the pusher stem 142 and the one-way clutch 42.

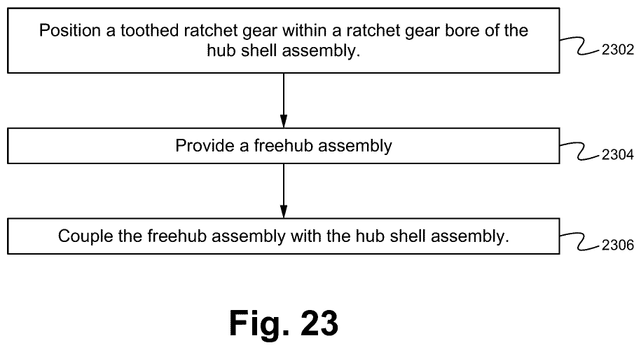

FIG. 23 illustrates a method of providing a hub assembly 1 according to some embodiments. As shown in FIG. 23, a toothed ratchet gear 180 is positioned within a ratchet gear bore 38 of the hub shell assembly 30 at the step 2302. The ratchet gear 180 is able to be aligned within the bore 38 such that splines 184 slide into corresponding hub shell spine channels 40 thereby preventing rotation of the gear 180 within the bore 38 with respect to the hub shell assembly 30. A freehub assembly 100 is provided at the step 2304. The freehub assembly 100 is coupled with the hub shell assembly 30 at the step 2306. In some embodiments, the coupling is able to comprise positioning an inner side of the pawl support member 102 is positioned the toothed ratchet gear 180 such that when the freehub assembly 100 is rotated in a first direction with respect to the hub shell assembly 30, the plurality of pawls 106 are able to pivot away from the pawl support member 102 (e.g. away from the deadband surface and/or the deadband recesses 132) until the plurality of pawls 106 engage teeth 185 of the toothed ratchet gear 180 causing the hub shell assembly 30 to rotate with the freehub assembly 100 in the first direction. In some embodiments, the method further comprises selectively inserting or removing a deadband adjustment key 108 within a deadband adjustment key slot 138 and/or selecting a deadband adjustment key 108 having a block 232 of a desired size. In particular, the method is able to comprise sliding trunk 234 of the deadband adjustment key 108 into the key slot 138 such that the block 232 of the deadband adjustment key 108 extends into the one of the deadband recesses 132 adjacent to one of the stop walls 136. Thus, when the freehub assembly 100 rotates with respect to the hub shell assembly 30 in a second direction, each of the pushing fingers 144 slide along the deadband surface until one of the pushing fingers 144 abuts the block 232 of the deadband adjustment key 108 (thereby reducing the size of the deadband within the hub assembly 1).

As a result, the method provides the advantage of providing a hub assembly having pawls 106 biased away from the ratchet gear 180 thereby ensuring a non-zero deadband length (regardless of the relative position of the pawls 106 and the teeth 185) and/or a silent hub assembly. Further, the method provides the advantage of enabling adjustment of a deadband length/amount of the hub assembly via a deadband adjustment key (to reduce or adjust kickback and/or sound produced by the hub) as desired by the user.

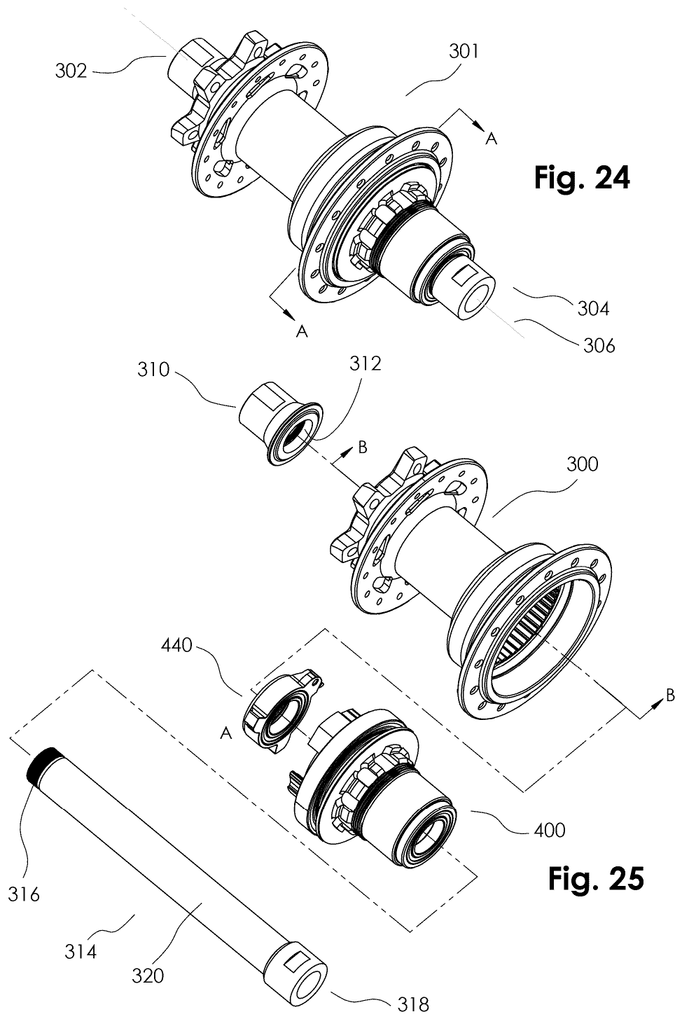

FIG. 24 illustrates a perspective view of an alternate hub assembly 301 according to some embodiments. As shown in FIG. 24, the hub assembly 301 comprises first end 302, second end 304, and hub central axis 306. FIG. 25 illustrates a perspective exploded view of the hub assembly 301 according to some embodiments. As shown in FIG. 25, the hub assembly 301 comprises a hub shell assembly 330, a pawl actuator assembly 440, a freehub body assembly 400, a hub axle 314 and a hub axle cap 310. The hub shell assembly 330, the pawl actuator assembly 440 and the freehub body assembly 400 are able to slide onto the hub axle 314 such that they are located on a hub axle bearing surface 320. The hub axle cap 310 is able to be threaded onto said axle 314 with a hub axle cap thread 312 threading onto a hub axle thread 316, such that the hub axle right end 318 is opposite said end cap 310 with the assemblies 330, 440 and 400 in between.

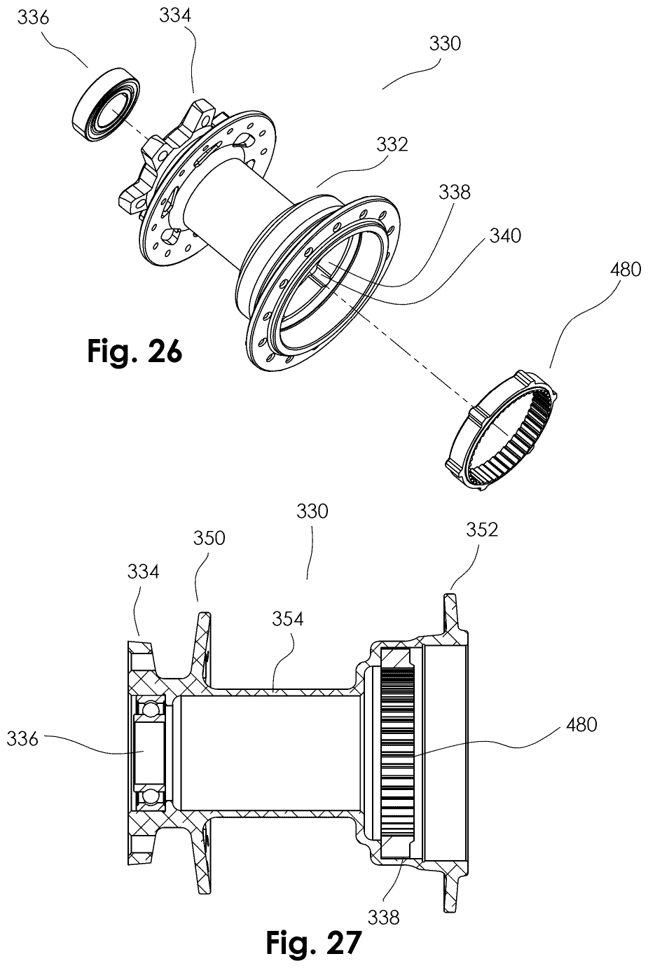

FIG. 26 illustrates an exploded perspective view of the hub shell assembly 330 according to some embodiments. As shown in FIG. 26, the hub shell assembly 330 comprises a hub shell 332, a hub shell disc flange 334, a hub shell bearing 336, a hub shell ratchet gear bore 338, one or more hub shell ratchet gear spline slots 340, and a toothed ratchet gear 480.

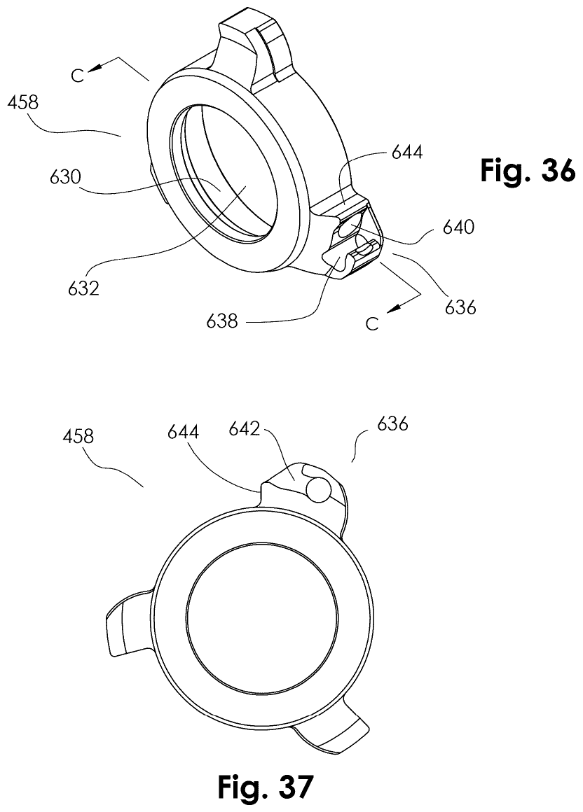

FIG. 27 illustrates a cross-section view of the hub shell assembly 330 at section line B of FIG. 25 according to some embodiments. As shown in FIG. 27, the hub shell 332 comprises a hub shell body 354, hub shell disc flange 334 (e.g. for coupling with a brake rotor), hub shell left spoke flange 350 and hub shell right spoke flange 352 (e.g. both for coupling with one or more spokes (not shown)). Further, as shown in FIG. 27, the hub shell bearing 336 is able to be positioned within a bearing cavity within the flange 334 (e.g. for receiving axle 314), and the ratchet gear 480 is able to be positioned within the hub shell ratchet bore 338. In particular, when positioned within the hub shell ratchet bore 338, each of a plurality of ratchet ring spline teeth 484 (see FIG. 36) of the ratchet ring 480 extend into a different one of the hub shell ratchet spline slots 340. As a result, when the ratchet ring 480 is rotated, the ratchet ring spline teeth 484 apply a force to the ratchet spline slots 340 thereby causing the hub shell 332 to similarly rotate. Alternatively, the ratchet ring 480 is able to be attached to hub shell 332 in other manners, including but not limited to, threaded connection, press-fit connection, splines, screws, keys and/or other attachment methods that result in the ratchet ring being affixed to the hub shell 332 such the movement of one causes the same movement of the other.

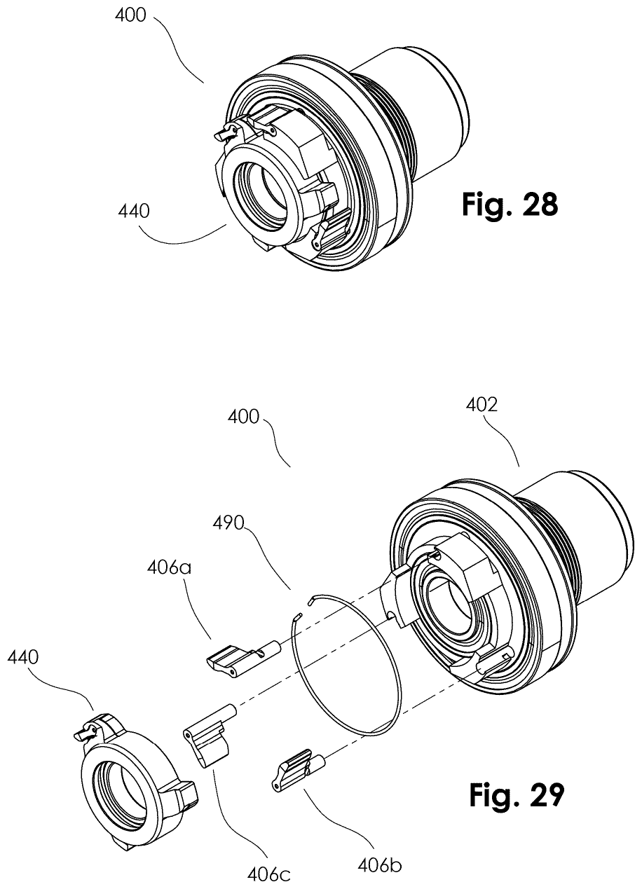

FIGS. 28 and 29 illustrate perspective and partially exploded perspective views, respectively, of the freehub body assembly 400 according to some embodiments. As shown in FIGS. 28 and 29, the freehub body assembly 400 comprises a bearing assembly (or pawl support member) 402, a pawl actuator assembly 440, one or more primary pawls 406a-c, and a pawl biasing element 490. In some embodiments, the biasing element 490 is a retraction spring. Alternatively, the biasing element 490 is able to be other types of biasing elements including, but not limited to, one or a combination of one or more leaf springs, one or more coil springs, one or more rubber bands, one or more magnets (e.g. placed in the freehub body under steel pawls 406), and/or any other kind of spring loading mechanism.

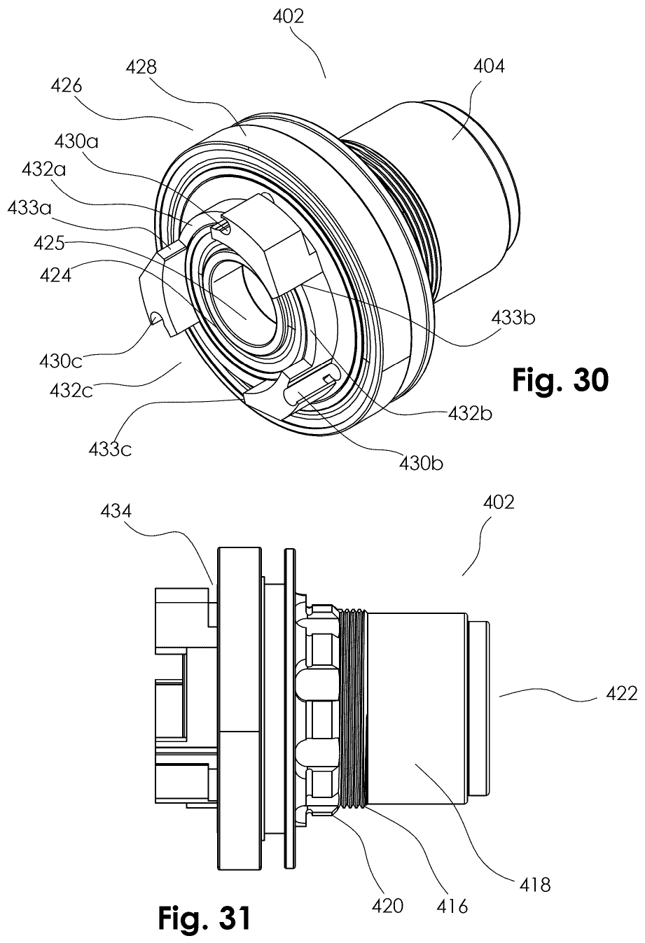

FIGS. 30 and 31 illustrate perspective and side views, respectively, of the bearing assembly 402 according to some embodiments. As shown in FIGS. 30 and 31, the bearing assembly 402 comprises a freehub external bearing 426 (with an external bearing outer race 428), a freehub internal bearing 424 (with an internal bearing inner race 425), one or more pawl cylinder pockets 430a-c, one or more pusher clearance openings 432a-c, one or more freehub pusher stop surfaces 433a-c, a cassette spline 420, a cassette mounting thread 416 and a cassette mounting boss 418, a retraction spring slot 434 and a freehub end bearing 422 (that is exposed on the right end of the freehub bearing assembly 402). The cassette spline 420 and/or cassette mounting boss 418 is able to receive a splined cassette (not shown) in order to coupled with a drive assembly of the bicycle 200 (e.g. the bicycle crank 208, the bicycle chainring 209, the bicycle chain 212, the derailleur 215 and/or other components). A cassette locking bolt (not shown) is able to threadably couple to the cassette mounting thread 416 to secure the cassette onto the spline 420. Although as shown in FIGS. 30 and 31, the bearing assembly 402 comprises three pawl cylinder pockets 430a-c, pusher clearance openings 432a-c and freehub pusher stop surfaces 433a-c, more or less pawl cylinder pockets 430a-c, pusher clearance openings 432a-c and freehub pusher stop surfaces 433a-care contemplated.

Similarly, although as shown in FIGS. 28 and 29, the freehub body assembly 400 comprises a pawl actuator assembly 440 having three lobes 444a-c, three primary pawls 406a-c and a single pawl biasing element 490, a pawl actuator assembly 440 having more or less lobes 444, more or less primary pawls 406a-c and/or more or less pawl biasing elements 490 are contemplated. In particular, the number of pockets 430a-c, pusher clearance openings 432a-c and freehub pusher stop surfaces 433a-c is able to correspond to the number of primary pawls 406a-c. The pusher clearance openings 432a-c are able to define a plurality of deadband cavities that are filled by the lobes 444a-c of the actuator 440 and the primary pawls 406a-c (at least in a fully retracted position). In some embodiments, one or more of the pusher clearance openings 432a-c are able to be different in size and therefore define a different size deadband. For example, one of the openings 432 is able to be sized such that the lobe 444a of the actuator 440 is able to simultaneously contact the stop surface 433 and the tip 704 of the primary pawl 406 within that opening 432 (e.g. thereby minimizing the deadband), and the remaining openings 432 are able to have larger sizes (e.g. the same or different larger sizes). In other words, each of the openings 432 is able to have the same or a different size than the remaining openings 432 thereby enabling the deadband to be adjusted based on which of the openings 432 the lobe 444a is positioned within.

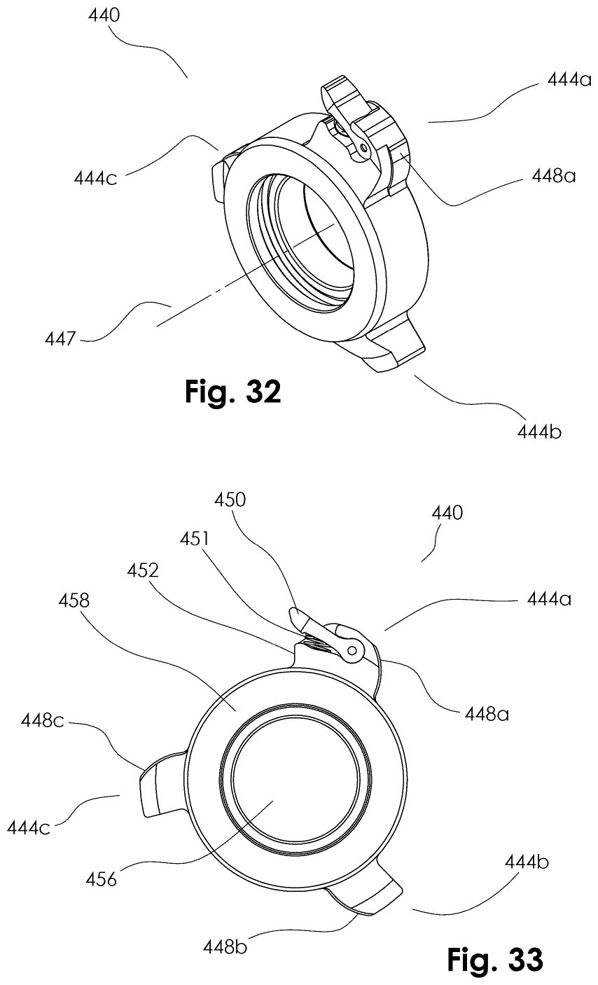

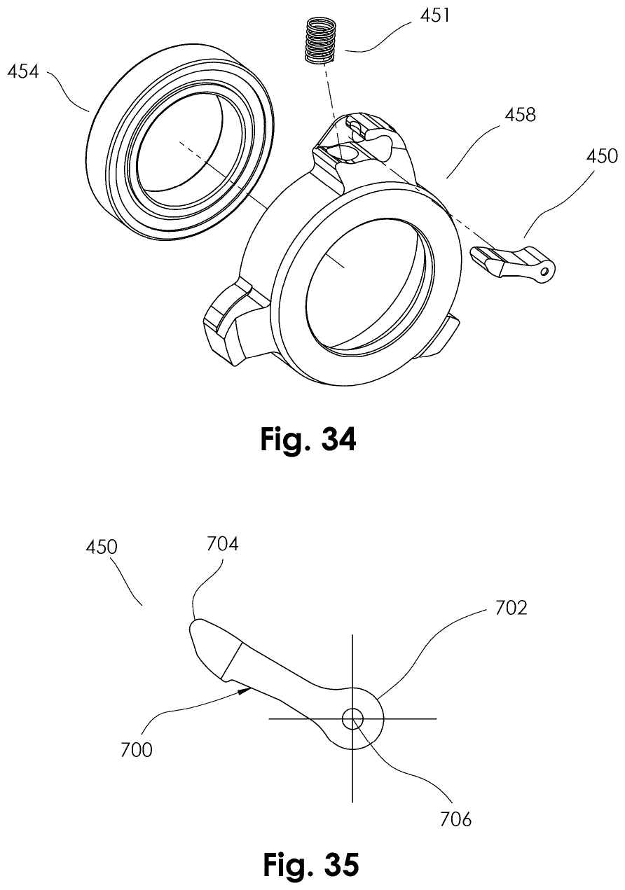

FIGS. 32, 33 and 34 illustrate perspective, right side and exploded perspective views, respectively, of the pawl actuator assembly 440 according to some embodiments. As shown in FIGS. 32 and 33, the pawl actuator assembly 440 comprises one or more pawl lobes 444a-c positioned about a pawl pusher center axis 447, one or more pusher cam surfaces 148a-c, a pawl pusher body 458, a pusher ratchet pawl 450, a pusher ratchet pawl biasing component 451, a pusher freewheel stop 452 and a pusher bearing 454. The bearing 454 is configured to fit within the bearing bore 630 of the pusher body 458 about the axis 447 and the ratchet pawl 450 is configured to fit within the pusher pawl pocket 642 (see FIG. 37).

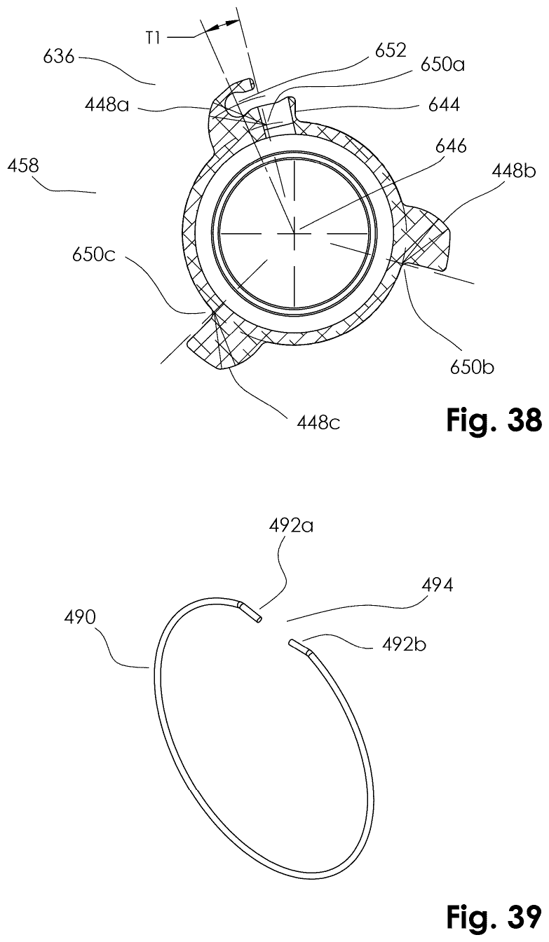

FIG. 35 illustrates a side view of the pusher ratchet pawl 450 according to some embodiments. As shown in FIG. 35, pusher ratchet pawl 450 comprises a pusher pawl spring surface 700, a pusher pawl driving surface 702, a pusher pawl tip 704, and a pusher pawl pivot center aperture 706. FIGS. 36 and 37 illustrate perspective and left side views, respectively, of the pawl pusher body 458 according to some embodiments. As shown in FIGS. 36 and 37, the pawl pusher body 458 comprises a pusher body bearing bore 630, a pusher body through hole 632, a pusher ratchet lobe 636 (which comprises a pusher pawl pocket 642, a pusher pawl driving surface 638, a pusher deadband stop 644, and a pusher spring hole 640. FIG. 38 illustrates a right-side section view of the pawl pusher body 458 at section line C of FIG. 36 according to some embodiments. As shown in FIG. 36, the pusher cam surfaces 448a-c each have a pusher cam surface center 650a-c positioned about a pawl pusher body center axis 646, and a pusher ratchet pawl 450 has a pivot axis 652. Between the pusher body center axis 646, the pusher cam surface 650a and the pusher pawl pocket pivot axis 652, a timing angle T1 is formed.

FIG. 39 illustrates a perspective view of the biasing element 490 according to some embodiments. As shown in FIG. 39, the biasing element 490 comprises a split/gap 494 with a pair of tangs 492a and b at each end of the element 490 adjacent to the gap 494.

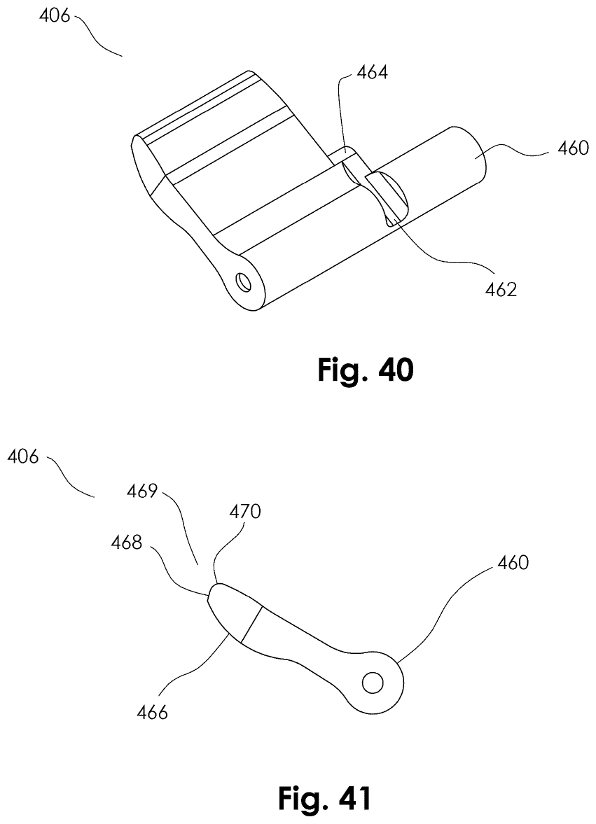

FIGS. 40 and 41 illustrate perspective and end views, respectively, of a primary pawl 406a-c according to some embodiments. As shown in FIGS. 40 and 41, the primary pawl 406a-c comprises a pawl cylinder 460, a pawl biasing element groove 462, a pawl spring pad 464, a pawl pusher cam surface 466, a pawl driving surface 468 and a pawl tip radius 470. The pawl pusher cam surface 466 is able to be designed for sliding over/along the pawl pusher cam surface 448a-c. The pawl driving surface 468 is configured to engage the ratchet tooth receiving face 486 and/or the pawl tip radius 470 is configured to fit within the valleys between the teeth 485 of the ratchet gear 480 (thereby engaging and causing the gear 480 to rotate with the freehub assembly 400).

The pawl cylinder 460 of each of the pawls 406a-c is able to slidably fit within one of the pawl cylinder pockets 430a-c. When positioned within one of the pockets 430a-c, the pawls 406a-c are able to pivot about a central axis of the pocket 430 between a retracted position toward a center of the assembly 402 and an extended position away from the center (toward the ratchet ring 480). The biasing element 490 is able to fit withing the gap 434 (see FIG. 31) at least partially surrounding or blocking the pivoting of pawls 406a-c away from the center of the assembly 402. In particular, the biasing element 490 is able to be positioned within the pawl biasing element groove 462 and adjacent to or around the pawl spring pad 464 of each of the pawls 406a-c in order to resist the pivoting away from the center of the assembly 402 and/or bias the pawls 406a-c in the retracted position. Indeed, by providing a shortened pad 464, the pawls 406a-c enable the biasing element 490 to have a smaller diameter and/or size and be closer to the center of the assembly 402.

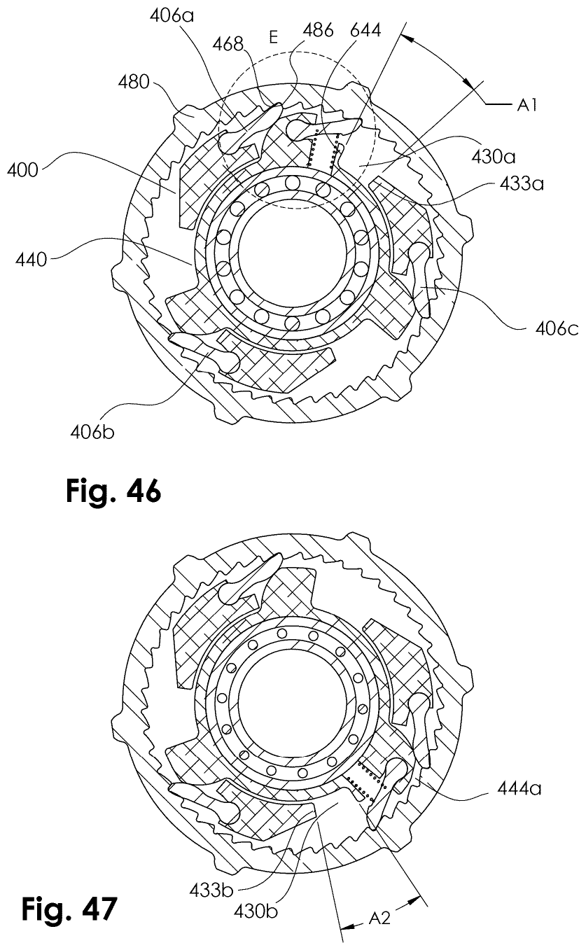

When in the extended position (see FIGS. 46 and 47), the pawls 406a-c are pivoted away from the center of the assembly 402 such that they are able to engage the teeth 485 of the ratchet gear 480 (e.g. contact a ratchet tooth receiving face 486 and/or a bottom of the valley between teeth 485). In some embodiments, when in the retracted position the pawls 406a-c are able to be positioned fully within the corresponding opening 432a-c (e.g. when the corresponding lobe 444 is able to slide to be adjacent to a stop surface 433a-c, but still does not impede or block the pivoting of the corresponding pawl 406a-c (see FIGS. 46 and 47). Alternatively, when in the retracted position the pawls 406a-c are able to at least partially (e.g. when despite being fully slid against the corresponding stop surface 433a-c, the corresponding lobe 444 impedes or blocks the pivoting of the corresponding pawl 406a-c toward the center of the assembly 402). In particular, by inserting the pawl actuator assembly 440 such that the lobe 444 with the ratchet pawl 450 is located in one of the openings 432a-c having a desired size (two or more of the openings 432a-c have different sizes), a user is able to adjust the retracted position by adjusting how close the lobes 444 are to the pawls 406a-c and/or the extent that the lobes 444 block the inward pivoting of the pawls 406a-c.

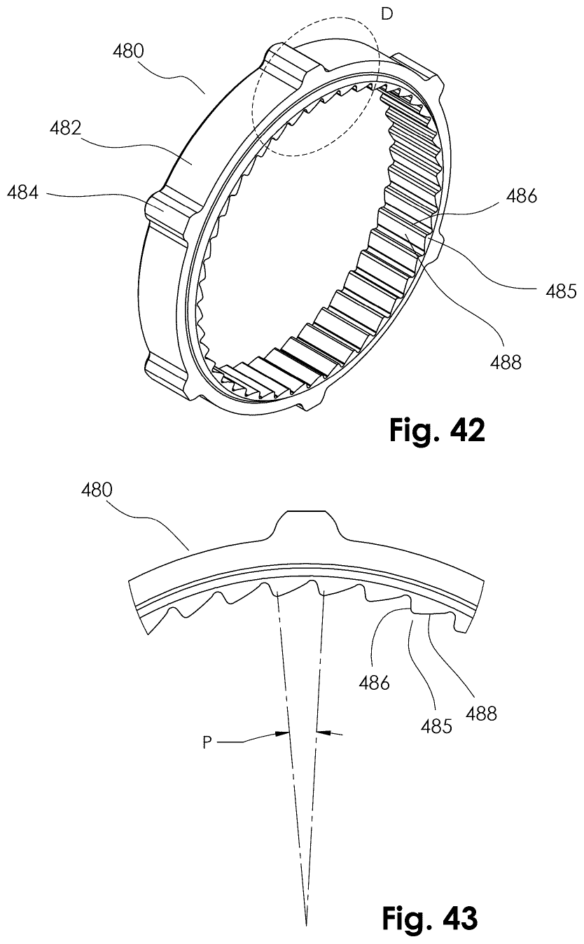

FIG. 42 illustrates a perspective view of the toothed ratchet gear 480 according to some embodiments. FIG. 43 illustrates a cutout side view of the toothed ratchet gear 480 in the cutout D shown in FIG. 42 according to some embodiments. As shown in FIGS. 42 and 43, the toothed ratchet gear 480 comprises a ring-shaped body having an outside surface 482, one or more outer splines 484 protruding from the outside surface 482 of the body, and a plurality of inner teeth 485 protruding from an inner surface of the body. Alternatively, the outer splines 484 are able to be replaced with an outer threading that screws into an inner threading of the hub shell ratchet bore 338 (which replaces the hub shell ratchet spline slots 340). Each of the inner teeth 485 have a ratchet tooth receiving face 486 and a ratchet tooth sliding face 488 with a valley formed where the sliding face 488 of each tooth meets the receiving face 486 of the adjacent tooth 485. A ratchet tooth pitch angle P is shown as the angle between two adjacent teeth 485. The sliding face 488 is able to be longer and/or make a smaller angle with respect to the adjacent inner surface of the body than the receiving face 486. Additionally, the shape, contour and/or size of the pawl driving surface 468 and the pawl tip radius 470 of each of the pawls 406a-c is able to compliment the shape of the valleys and/or curvature of the sliding face 488.

As a result, when the pawls 406a-c are extended such that they contact the teeth 485 and moved/rotated in a direction from the valley in between teeth 485 along the adjacent sliding face 488, the smaller angle enables the pawls 406a-c to slide over the teeth 485 without engaging the teeth 485. In contrast, when moved/rotated in the opposite direction from the valley in between teeth 485 along the adjacent receiving face 486, the larger/steeper angle causes the pawl driving surface 468 and/or the pawl tip radius 470 to catch against the receiving face 486 and/or within the valleys thereby engaging the teeth 485 and forcing the ring to rotate in the same direction as the pawls 406a-c. Alternatively, the sliding and receiving faces 486, 488 are able to be the same length and/or angle.

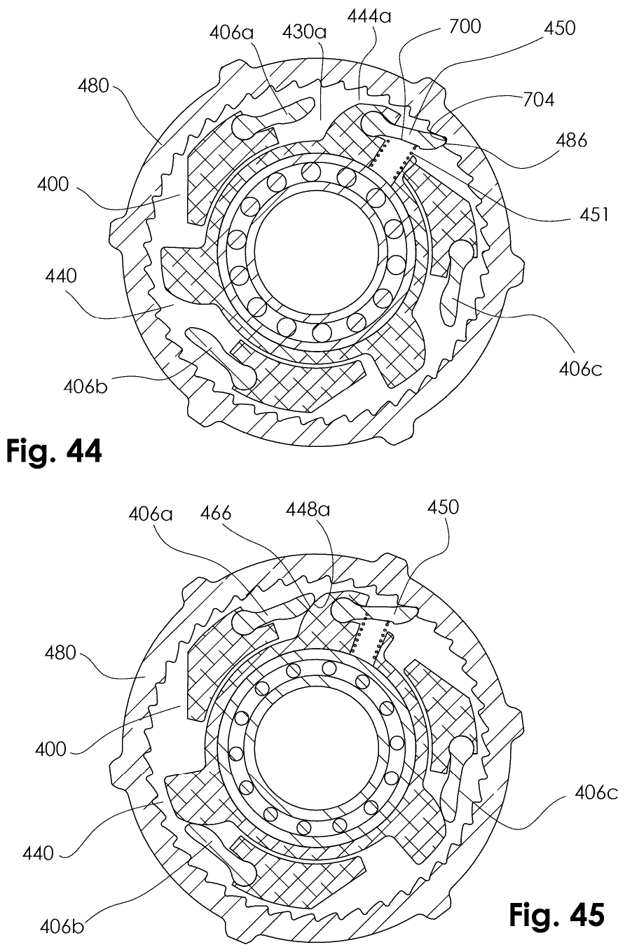

FIG. 44 illustrates a left side section view of the pawl actuator assembly 440, freehub body assembly 400 and ratchet ring 480 of the hub assembly 301 at section line A of FIG. 24 according to some embodiments. The remainder of the hub shell assembly 330 components are excluded from the view for clarity. The hub assembly 301 is shown in the state of freewheeling, when the hub shell 330 is over-running the freehub body 400, therefore ratchet ring 480 is rotating clockwise relative to the pawl actuator assembly 440 and freehub body assembly 400. In this assembly 301, pawl lobe 444a has been installed in pusher clearance opening 432a to set the deadband A1 (see FIG. 46). Also shown in their retracted, freewheeling positions are primary pawls 406a-c, which are being held in the retracted position by the biasing element 490. The pusher ratchet pawl 450 is engaging ratchet tooth receiving face 486 with its pusher pawl tip 704, while pusher ratchet pawl biasing component 451 is loading said pawl in contact with pusher pawl spring surface 700. As a result, while the component 451 maintains contact between the ratchet pawl 450 and the ratchet ring 480, the primary pawls 406a-c do not make contact with the ratchet ring 480 (i.e. they are in the retracted position). Indeed, this contact between the ratchet pawl 450 and the ratchet ring 480 causes the lobes 444a-c of the pawl actuator assembly 440 to move clockwise with respect to the primary pawls 406a-c thereby biasing the lobes 444a-c against the stop surfaces 433a-c (and maximizing the deadband length). In some embodiments, the bearing 454 is designed to reduce friction caused by the rotation of the assembly 440 to minimize the amount of force that is required to be applied to the lobe 444a to cause the lobes 444a-c to press against the stop surfaces 433a-c. Indeed, the minimization of this rotational friction provides the benefit of ensuring that, during the freewheeling and/or transition states, the deadband length is constantly maintained and/or reset due to this rotational force by the ratchet ring 480 on the lobe 444a urging the lobes 444a-c of the assembly 440 toward the stop surfaces 433a-c.

FIG. 45 illustrates a left side section view of the pawl actuator assembly 440, freehub body assembly 400 and ratchet ring 480 of the hub assembly 301 at section line A of FIG. 24 during a transitional state between freewheeling (e.g. retracted pawls) and full hub engagement (e.g. extended pawls) according to some embodiments. At this point in the engagement movement, freehub body assembly 400 has rotated clockwise relative to the ratchet ring 480 and the pawl actuator assembly 440, and the primary pawls 406a-c have contacted pusher cam surfaces 448a-c with their pawl cam surface 466 (but the pawls 406a-c have not begun to rotate relative to freehub body assembly 400 to begin engagement with ratchet ring 480).

FIG. 46 illustrates a left side section view of the pawl actuator assembly 440, freehub body assembly 400 and ratchet ring 480 of the hub assembly 301 at section line A of FIG. 24 with the hub 301 in the fully engaged and driving configuration according to some embodiments. The freehub body assembly 400 has rotated further clockwise relative to the ratchet ring 480 and the pawl actuator assembly 440 (e.g. due to pedaling of the bicycle) such that primary pawls 406a-c have now slid along pusher cam surfaces 448a-c until the pawl driving surface 468 of each pawl 406a-c has contacted a proximate ratchet tooth receiving face 486. Due to the ratchet pawl 450 being pushed by the biasing component 451 into constant alignment between two teeth 485 of the ratchet ring 480 (as the ratchet ring 480 rotates clockwise and slips past the ratchet pawl 450 during the freewheeling or transition state), the primary pawls 406a-c will also be aligned between two teeth 485 of the ratchet ring 480 when they move into the extended position (e.g. fully engaged/driving configuration). Thus, the pawl actuator assembly 440 provides the benefit of ensuring that not only can the desired deadband be adjusted (based on the size of the opening 432a-c within which the lobe 444a is positioned), but also ensuring that the primary pawls 406a-c are all in alignment with a corresponding ratchet tooth receiving face 486 (between two teeth 485). Moreover, due to the distribution of the lobes 444a-c and the pawls 406a-c, all three of the primary pawls 406a-c contact the ratchet ring 480 in synchrony, and thus torque is being transmitted from freehub body assembly 400 to the ratchet ring 480 via said primary pawls 406a-c. FIG. 46 further shows the mechanical deadband angle A1, which is the mechanical angle through which freehub body assembly 400 rotates relative to pawl actuator assembly 440 from resting, freewheeling position until primary pawls 406a-c are fully engaged.

FIG. 47 illustrates a left side section view of the pawl actuator assembly 440, freehub body assembly 400 and ratchet ring 480 of the hub assembly 301 at section line A of FIG. 24 with an alternate configuration of the components according to some embodiments. As shown in FIG. 47, the pawl lobe 444a is installed in a different one of the pusher clearance openings 432b having a different size thereby developing an alternative mechanical deadband angle A2 between pusher deadband stop 644 and freehub pusher stop surface 433b. Thus, the deadband angle is able to be adjusted as desired based on which of the pusher clearance openings 432a-c the pawl lobe 444a is placed into during assembly.

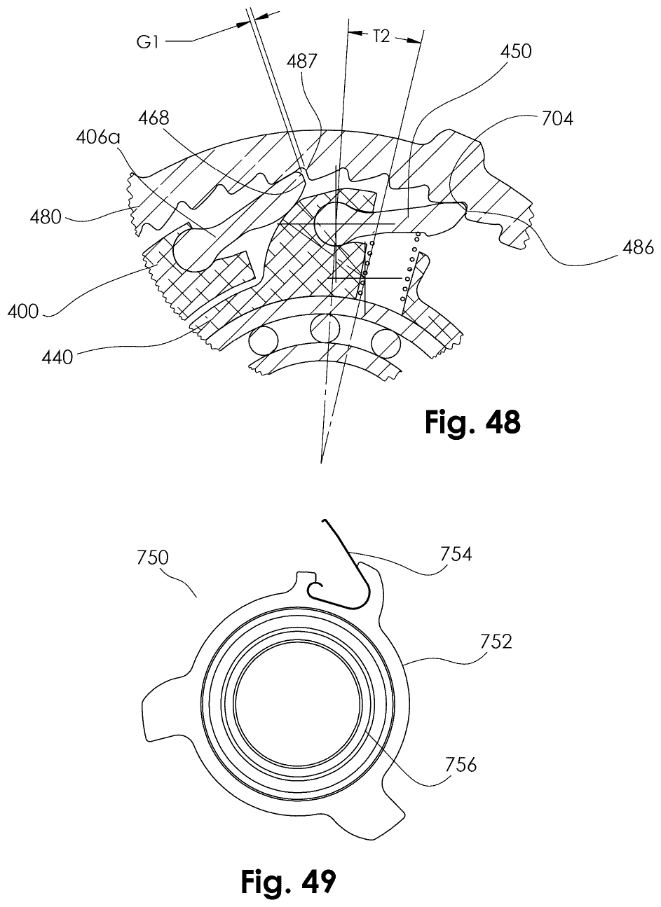

FIG. 48 is a partial detail section view at circle cutout E of FIG. 46 according to some embodiments. As shown in FIG. 48, the freehub body assembly 400, the pawl actuator assembly 440 and the ratchet ring 480, depict one aspect of the operation, wherein pusher ratchet pawl 450 is fully engaged with the ratchet ring 480, and the pusher pawl tip 704 is in contact with ratchet tooth receiving face 486. In this aspect, the timing angle T2 has been calculated such that when the pusher ratchet pawl 450 contacts and/or is fully engaged with the ratchet ring 480, rather than the pawl driving surface 468 of the primary pawl 406a contacting the second ratchet tooth receiving face 487, a pawl tip clearance G1 is left between the pawl driving surface 468 of the primary pawl 406a and a second ratchet tooth receiving face 487. As the timing angle T2 is increased, a pawl tip clearance G1 is correspondingly increased (where the pawl tip 469 is in contact with ratchet tooth sliding face 488, but the pawl driving surface 468 is not yet in contact with ratchet tooth receiving face 487). Thus, this pawl tip clearance G1 is able to be adjusted to be larger or smaller (or nonexistent) as desired by changing the length/size/dimensions of the lobes 444a-c and/or the primary pawls 406a-c. Under some circumstances it is preferable to design G1>0, so that deflection and flex in the components of the hub force pawl driving surface 468 into contact with ratchet tooth receiving face 488. In fact this enables the hub to operate more smoothly with less noise, as a small amount of friction between the pawl and ratchet control the collision between the two parts during energetic engagement. Additionally, this provides the benefit of enabling an amount of give to be provided by the assembly 301 while still ensuring sufficient alignment of the primary pawls 406a-c.

In operation, the hub assembly 301 operates in two modes. In the first mode, “freewheeling,” the hub 301 freewheels when the bicycle 200 is rolling forward and the pedal crank 208 remains stationary. The cranks 208, chain 212, cassette 214 and freehub body assembly 400 remain motionless relative to the bicycle frame, while the rear wheel 202 rotates forward. In the second mode, the hub 301 drives the bicycle 200 forward when the pedal cranks 208 are pedaled forward by the bicycle rider. The chainring 209 rotates and applies tension to the bicycle chain 212, rotating the bicycle cassette 214 which is rigidly mounted to the freehub body assembly 400, and the freehub body assembly 400 applies torque to the hub shell 330, rotating the wheel 202 and driving the bicycle 200 forward. In this manner, the rider propels the bicycle 200 forward by rotating the pedal crank.

As described above, when the complete hub assembly 301 freewheels, the primary pawls 406a-c are retracted inboard towards the freehub bearing assembly 402 and the hub shell assembly 330 rotates clockwise relative to the hub axle 314 about the hub center axis 306, while the freehub body assembly 400 remains stationary. As the hub shell assembly 330 freewheels, the actuator ratchet pawl 450 slides over the ratchet ring 480, ratcheting against the ratchet teeth 485 as the actuator ratchet pawl biasing component 451 presses the actuator pawl tip 704 against the ratchet ring 480. Accordingly, the pawl actuator assembly 440 is therefore driven clockwise relative to the hub axle 314 by pressure applied to the lobe/ratchet pawl 450 by the teeth 485 of the ratchet ring 480. Also during freewheeling, the pawl retraction element 490 contacts the pawl spring pad 464 and presses each primary pawl 406a-c inward towards the center of the hub 400, allowing the ratchet ring 480 to rotate freely around the primary pawls 406 with no contact.

The biasing element 490 is able to be configured such that it provides a constant inward force towards the hub center axis 306 on the pawl spring pads 464 throughout the entire free range of the primary pawls 406a-c in the assembly. In some embodiments, wherein the biasing element 490 is a spring, this force is able to be controlled by sizing the resting diameter of the spring and the spring wire diameter. In such embodiments, the wire spring tangs 492a-b maintain the spring's radial location relative to the freehub base body 404, and the spring axial location is maintained by the retraction spring slot 434. The primary pawls 406a-c axial location is maintained by the wire spring resting in each pawl spring groove 462. The actuator freewheel stop 452 is therefore able to be pressed against one of the freehub actuator stop surfaces 433a-c (wherein the pawl actuator assembly 440 is able to be installed in any of the three actuator cylindrical pockets 430a-c defining different deadband sizes).

The deadband of the hub 301 is developed as the rider transitions from coasting to moving the pedal cranks and actively pedaling the bicycle 200 forward. As the pedal cranks begin moving, the freehub bearing assembly 302 begins rotating clockwise relative to the hub center axis 306, until the speed of the freehub bearing assembly 402 matches the rolling speed of the hub shell assembly 330. Once these rotational velocities match, the pawl actuator assembly 440 will no longer be rotated by the ratchet ring 480 (owing to the drag force induced on the pawl actuator assembly 440 by the actuator ratchet pawl 450 interacting with the ratchet ring 480) thereby causing/enabling the actuator freewheel stop 452 to move away from the corresponding freehub actuator stop surface 433a-c. In particular, the pawl actuator 440 rotates counter-clockwise relative to the freehub bearing assembly 402 and as this rotation occurs, the actuator cam surface 448a moves towards and comes into contact with the primary pawl 406a and its pawl cam surface 466. Once this happens the primary pawl 406a begins to rotate around the pawl cylinder 460, such that the pawl tip radius 470 moves outward towards the ratchet ring 480. Since the actuator ratchet pawl 450 has engaged the ratchet ring 480 in one of it's ratchet tooth receiving faces 486, the pawl tip radius 470 contacts the ratchet ring 480 in alignment with the valley between two of the ratchet teeth 485. The pawl tip radius 470 slides over a ratchet tooth sliding face 488 until the pawl driving surface 468 contacts a ratchet tooth receiving face 486. When this contact occurs, torque is transferred from the freehub bearing assembly 402 to the hub shell assembly 330 via the ratchet pawl 406 in compression.

Once underway, the rider may cease pedaling to resume freewheeling. When torque is no longer applied to the freehub bearing assembly 402, the ratchet ring 480 resumes clockwise rotation relative to the freehub bearing assembly 402, and the ratchet pawl 406 is forced away from the ratchet ring 480 as the pawl tip radius 470 slides back down the ratchet tooth sliding face 488. Simultaneously, the pawl actuator 440 is free to rotate clockwise with the hub shell assembly 330, and is helped along by the sliding contact between the actuator cam surfaces 448a-c and the pawl cam surface 466. Once the ratchet primary pawls 406a-c have returned to their resting positions, the are held in place by the biasing clement 490. It can be seen that during freewheeling, as the chain vibrates or the chainstays grow from L1 to L2, the mechanical deadband in the hub 301 will stop the hub 301 from engaging, unless chain movement exceeds the deadband of the hub 301. Thus, the hub 302 provides the advantage of removing unwanted kickback caused by such an engagement.

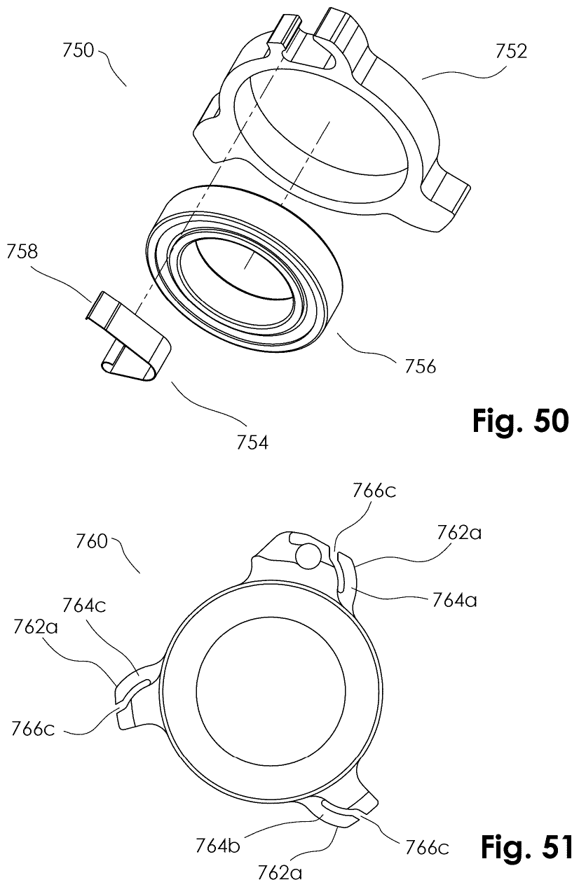

FIGS. 49 and 50 illustrate left side and exploded perspective views, respectively, of an alternative actuator assembly 750 according to some embodiments. The alternative actuator assembly 750 is able to be substantially similar to the actuator assembly 440 except for the differences described herein. As shown in FIG. 49, the alternative actuator assembly 750 comprises a spring activated pusher 752, a timing spring 754 having a spring tip 758, and a spring pusher bearing 756. In some embodiments, the timing spring 754 is a separate piece (e.g. formed by a separate material, such as plastic or metal) that is inserted into a cavity within the body of the pusher 752. Alternatively, the timing spring 754 is able to be combined with the pusher 752 such that it is formed by a protrusion of the body of the pusher 752 that extends from the pusher 752 in the same manner as shown in FIG. 49. In either case, the spring 754 is able to operate in the same manner as the ratchet pawl 450 (with the spring tip 758 continuously sliding against the ratchet 480 between the teeth 485) to facilitate the alignment of the primary pawls 406a-c.

FIG. 51 illustrates a left side view of a second alternative actuator assembly 760 according to some embodiments. The second alternative actuator assembly 760 is able to be substantially similar to the assemblies 440 and/or 750 except for the differences described herein. As shown in FIG. 51, each lobe of the alternative actuator assembly 760 comprises a spring pawl cam surface 762a-c, a spring arm 764a-c and a spring arm gap 766a-c. As a result, the spring arms 764a-c are able to flex into the gap 766a-c when contacted on the cam surface 762a-c by the primary pawls 406a-c thereby cushioning the force of the contact. In other words, the pressure in the contact between spring pawl cam surface 762a and pawl cam surface 466 will deflect spring arm 764a-c of the primary pawls 406a-c. Indeed, this deflection provides the benefit of being able to accommodate variation in the alignment between the actuator assembly and the ratchet ring 480, owing to manufacturing variation, misalignment under riding loads, or otherwise allow for smoother operation of the hub.

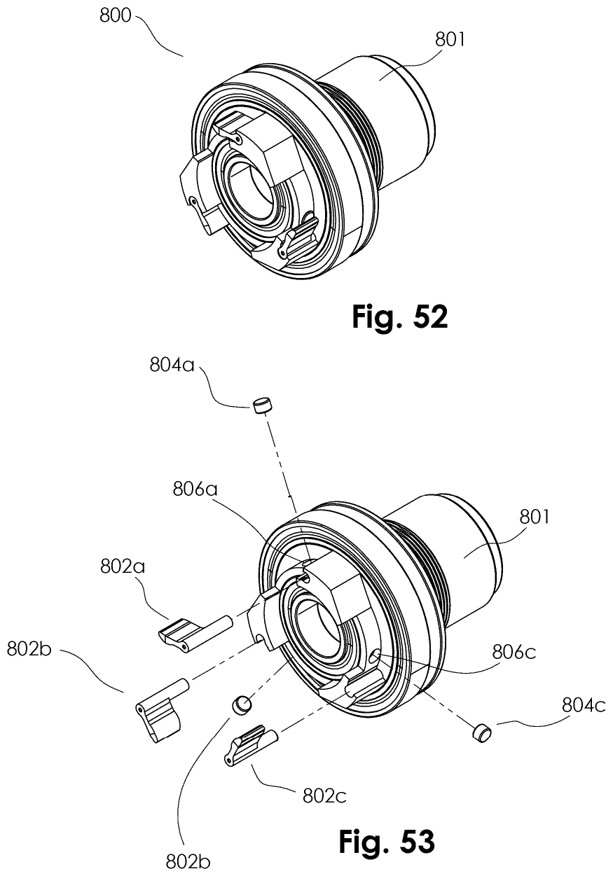

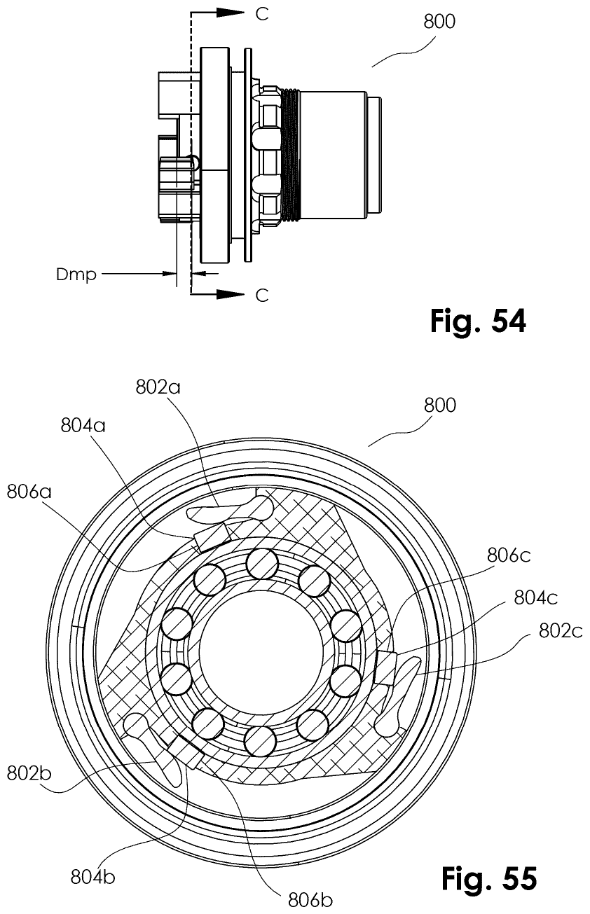

FIGS. 52, 53 and 54 illustrate perspective, exploded perspective and rear views, respectively, of a magnetic freehub assembly 800 according to some embodiments. FIG. 55 illustrates a left side section view of the magnetic freehub assembly 800 at section line C of FIG. 54 according to some embodiments. The magnetic freehub assembly 800 is able to be substantially similar to the freehub assembly 400 and/or utilized within the hub assembly 301 in a substantially similar manner except for the differences described herein. Specifically, as shown in FIGS. 52-55, the biasing element 490 of the magnetic freehub assembly 800 comprises one or more magnets 804a-c positioned within one or more magnet mounting holes 806a-c located in the body 801 of the assembly 800. Further, the primary pawls 406a-c of the assembly 800 are able to be replaced with magnetic primary pawls 802a-c (e.g. metallic or other magnetic or partially magnetic materials). Moreover, the pawl spring groove 462 and the pawl spring pad 464 of the primary pawls 406a-c are able to be omitted from the magnetic primary pawls 802a-c (since the magnets 804a-c do not encircle the magnetic primary pawls 802a-c). In such embodiments, the pawls 802a-c and magnets 804a-c are able to be oriented such that they magnetically attract one another. Additionally, the number of magnets 804 and holes 806 are able to match the number of pawls 802 and/or be a multiple of the number of pawls 802 (e.g. two magnets/holes per pawl).

In operation, like the biasing element 490, the magnets 804a-c (which are affixed within the holes 806a-c) provide a biasing force to the adjacent one of the pawls 802 that biases them into the retracted position. This attractive magnetic force presses each primary magnetic pawl 802a-c inward towards the center of the hub, ensuring the primary magnetic pawls 802a-c remain disengaged from the ratchet ring 480 during freewheeling conditions. This magnetic retraction allows the ratchet ring 480 to rotate freely around the pawls 802a-c without contact, thereby enabling silent coasting.

As shown in FIG. 55, in some embodiments the magnets/holes 804, 806 are able to be offset from the centerline of the pawls 802 by a pawl to magnet center distance Dmp such that they are positioned more closely to the right end 304 of the assembly 800. As a result, each of the magnets 804 not only provide a biasing force to the adjacent one of the pawls 802 that biases them into the retracted position, the magnets also provide a biasing force to the pawls 802 that pulls them toward the right end 304 of the assembly 800 thereby holding them within the cylindrical pockets 430. Alternatively, one or more of the magnets/holes 804, 806 are able to be positioned on the midline and/or offset in the other direction.

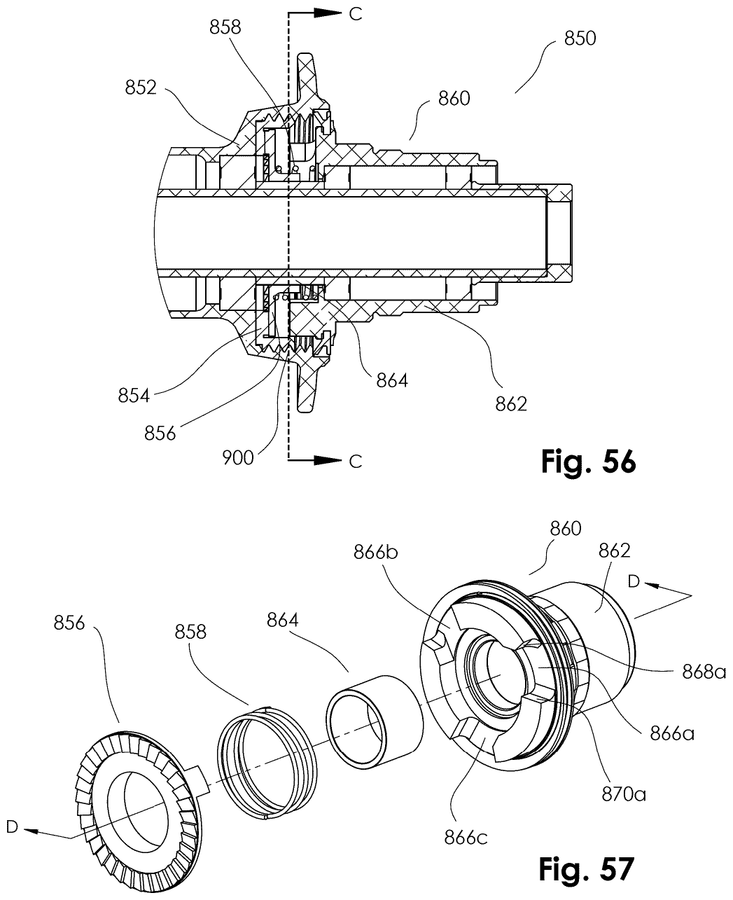

FIG. 56 illustrates a right side section view of a face gear hub assembly 850 at section line D in FIG. 57 according to some embodiments. FIG. 57 illustrates an exploded perspective view of a face gear freehub assembly 860 according to some embodiments. As shown in FIGS. 56 and 57, the face gear hub assembly 850 comprises the face gear freehub assembly 860, a threaded hub shell 852, an actuator bushing 864, an actuator face gear 856 and a shell driving face gear 854. The face gear freehub assembly 860 further comprises a face gear spring 858 that is located between said actuator face gear 856 and face gear freehub body 862. Further, the face gear freehub body 862 comprises deadband grooves 866a-c, and freehub freewheeling surface 868a and torque driving surface 870a are indicated for one instance of deadband groove 866a. Like the openings 432a-c, the size of the deadband grooves 866a-c determine the size of the deadband.

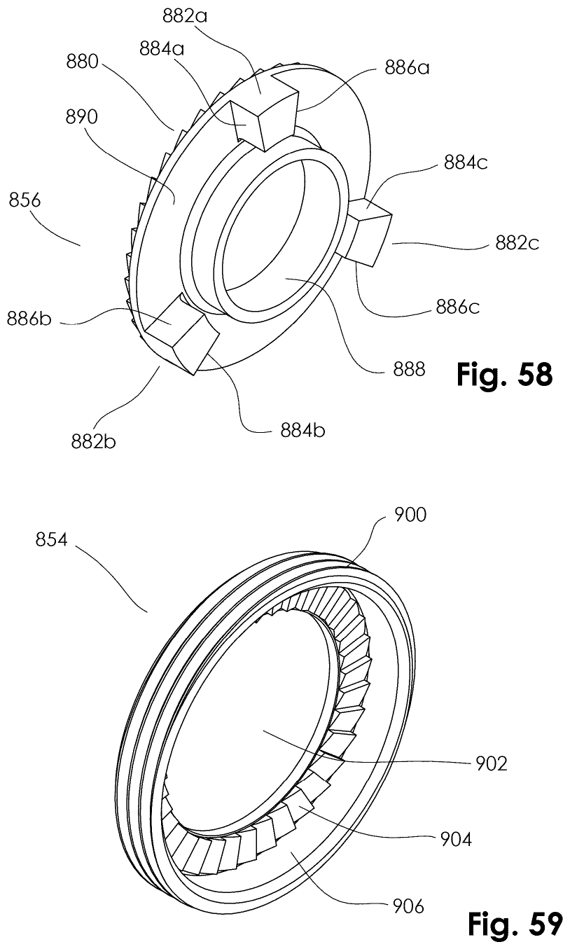

FIG. 58 illustrates a perspective view of the actuator face gear 856 according to some embodiments. As shown in FIG. 58, the actuator face gear 856 comprises a driving face gear 880, a face actuator through hole 888, a face actuator spring surface 890, and one or more deadband lobes 882a-c. The deadband lobes 882a-c are comprised of lobe freewheeling surfaces 886a-c and lobe torque driving surfaces 884a-c.

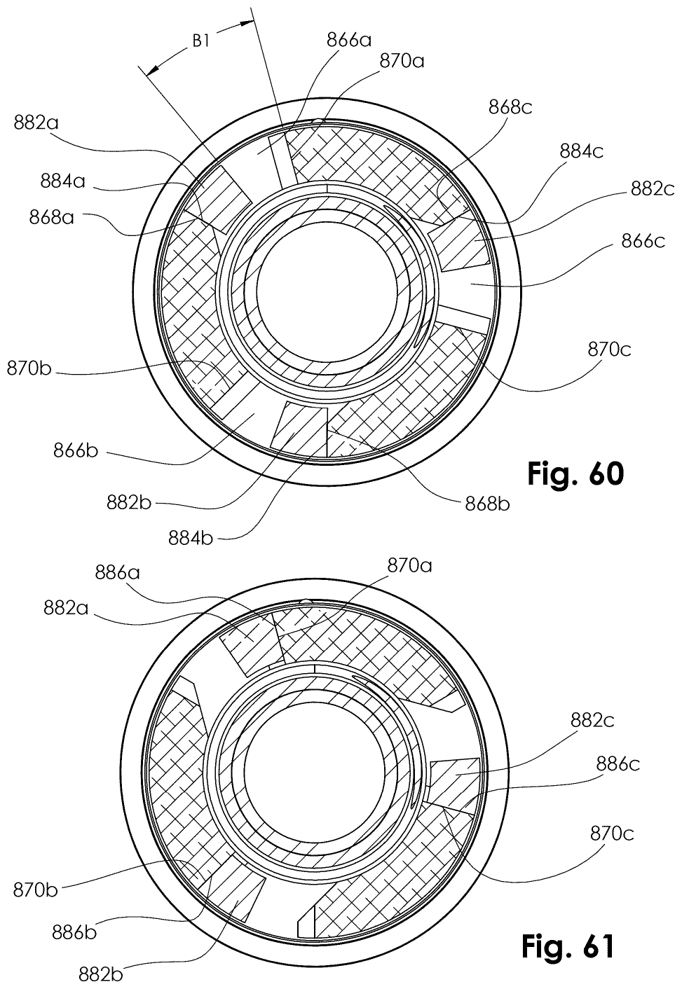

FIG. 59 illustrates a perspective view of the shell driving face gear 854 according to some embodiments. As shown in FIG. 39, the shell driving face gear 854 comprises a driven face gear 906, a driven face gear tooth 904, a face gear external thread 900 and a driven face gear through hole 902. FIG. 60 illustrates a section view of the face gear freehub assembly 860 at the section line C in FIG. 56 in the freewheeling orientation showing face gear deadband angle B1 according to some embodiments. In this orientation, lobe freewheeling surfaces 886a-c are pressed against freehub freewheeling surface 868a-c, as the hub shell 852 rotates past the freehub body 862.

FIG. 61 illustrates a section view of the face gear freehub assembly 560 at the section line C in FIG. 56 the torque transmitting orientation according to some embodiments. In this orientation, the torque driving surface 870a-c are pressed against the lobe torque driving surfaces 884a-c, as the freehub body 862 transmits torque through deadband lobes 882a-c, into the actuator face gear 856 and through the face gear connection into shell driving face gear 854.

In operation, the face gear hub assembly 850 utilizes the pair of face gears 856, 854 to transmit torque from the face gear freehub assembly 860 to the hub shell 852 and incorporates a fixed mechanical deadband B1. The deadband is created by the specific interaction between the actuator face gear 856 (FIG. 587) and the face gear freehub body 862 (FIG. 60). The actuator face gear 856 features three deadband lobes 882a-c that protrude axially. Correspondingly, the face gear freehub body 862 has three deadband grooves 866a-c machined into its surface, and said lobes 882a-c reside within the grooves 866a-c during operation. The width of the deadband lobes 882a-c is designed to be smaller than the circumferential length of the deadband grooves 866a-c. This size difference creates a defined amount of rotational play between the face gear freehub body 862 and the freehub face gear 840. This rotational play constitutes the fixed mechanical deadband of the hub assembly 850.

During freewheeling, the bicycle's wheel and the attached threaded hub shell 852 rotate forward at a higher speed than the face gear freehub assembly 860, which remains stationary with the pedals. The shell driving face gear 854 which is rotationally fixed to the hub shell, rotates over the driving face gear 880. The ramped shape of the face gears 856, 854 cause them to slide and ratchet over one another. This sliding action forces the actuator face gear 856 to move axially away from the shell driving face gear 854, compressing the face gear spring 858 and disengaging the drive. In this state, the deadband lobes 882a-c rest within the deadband grooves 866a-c without transmitting torque, and contact between the lobe torque driving surfaces 884a-c and freehub freewheeling surface 868a-c carries the actuator face gear 856 along at the same speed as the threaded hub shell 852.

When the rider begins to pedal, the face gear freehub assembly 860 starts to rotate in the driving direction thereby causing the lobe torque driving surfaces 884a-c move within the grooves 866a-c toward the corresponding torque driving surface 870a-c of the grooves 866a-c (thereby traversing the deadband). At the same time, the face gear spring 858 constantly urges the actuator face gear 856 into engagement with the shell driving face gear 854. Thus, due to the ramped shape of the face gear teeth, these components form a one-way clutch that is always biased towards a locked, torque-transmitting state. Once the deadband has been fully traversed (e.g. when the lobe torque driving surfaces 884a-c make firm contact with the corresponding torque driving surface 870a-c of the grooves), the entire assembly is rotationally locked. Accordingly, this clutch mechanism is engaged to transmit torque from the freehub assembly 860 to the shell 852 and the full input torque from the pedals is transferred through the engaged face gears 856, 854 to the hub shell 852, driving the bicycle forward.

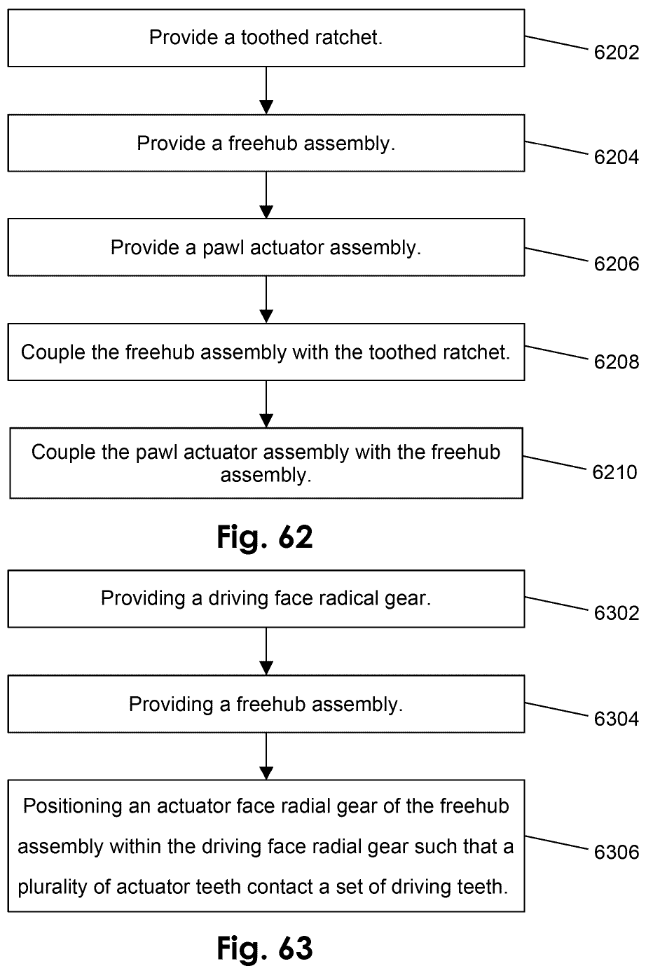

FIG. 62 illustrates a method of providing a bicycle hub system according to some embodiments. As shown in FIG. 62, a toothed ratchet 480 is provided at the step 6202. A freehub assembly 400 is provided at the step 6204. A pawl actuator assembly 440 is provided as the step 6206. The freehub assembly 400 is coupled with the toothed ratchet 480 such that the plurality of primary pawls 406a-c are positioned within the toothed ratchet gear 480 at the step 6208. The pawl actuator assembly 440 is coupled with the freehub assembly 400 such that each lobe of the lobes 444a-c of the pawl actuator assembly is positioned along the arc between two of the primary pawls 406a-c at the step 6210. As a result, as described above, when the hub shell assembly moves about the central axis in a first direction relative to the pawl actuator assembly, the ratchet member slidably contacts the toothed ratchet gear and the primary pawls do not contact the toothed ratchet gear. Additionally, as described above, when the hub shell assembly rotates about the central axis in a second direction relative to the pawl actuator assembly, the ratchet member engages a tooth of the toothed ratchet gear such that the pawl actuator assembly begins to move with the hub shell assembly about the central aperture relative to the freehub assembly. Further, as described above, upon contacting the primary pawls when moving in the second direction, the lobes of the pawl actuator assembly cause the primary pawls to pivot away from the central axis until the primary pawls each engage a different tooth of the toothed ratchet gear. In some embodiments, coupling the pawl actuator assembly with the freehub assembly comprises choosing a desired deadband length by inserting the lobe 444a into an opening 332a-c having the desired length/deadband length.

FIG. 63 illustrates a method of providing a bicycle hub system according to some embodiments. As shown in FIG. 63, a driving face radial gear having an inner cavity face with a set of driving teeth is provided at step 6302. A freehub assembly is provided at the step 6304. The freehub assembly including an outer hub sprocket attachment feature, an actuator face radial gear and a face gear support structure having a plurality of deadband grooves, wherein the actuator face gear has a first face including a plurality of actuator teeth and a second face having a plurality of deadband lobes positioned within the deadband grooves. The actuator face radial gear is positioned within the driving face gear such that the plurality of actuator teeth contact the set of driving teeth at the step 6306. As a result, when the hub shell assembly moves about the central aperture in a first direction relative to the freehub assembly, the actuator teeth slide past the driving teeth without engaging the driving teeth. Further, when the hub shell assembly moves about the central aperture in a second direction relative to the freehub assembly, the actuator teeth engage the driving teeth such that the hub shell assembly and the actuator face gear move together.

The system, method and device described herein has numerous advantages. In particular, the system, method and device provide the advantage of providing a hub assembly having pawls biased away from the ratchet gear thereby ensuring a non-zero deadband length (regardless of the relative position of the pawls and the teeth). Further, the system, method and device provides the advantage of enabling adjustment of a deadband length/amount of the hub assembly via either a deadband adjustment key (to reduce or adjust kickback and/or sound produced by the hub) or insertion of the timing lobe of the actuator assembly into an opening of a certain size as desired by the user. Further, the system, method and device provide the advantage of ensuring the desired timing/alignment of the primary pawls with the ratchet ring by utilizing the ratchet pawl as a timing/alignment mechanism. Additionally, the system, method and device provide the advantage of enabling the deadband distance to be adjusted and/or configured for silent freewheeling.

The present invention has been described in terms of specific embodiments incorporating details to facilitate the understanding of the principles of construction and operation of the invention. Such references, herein, to specific embodiments and details thereof are not intended to limit the scope of the claims appended hereto. It will be apparent to those skilled in the art that modifications can be made in the embodiments chosen for illustration without departing from the spirit and scope of the invention. For example, although the hub assemblies 1, 301 are described herein with respect to a bicycle wheel, it is understood that the assemblies 1, 301, hub shell assemblies 30, 330 and/or the freehub assemblies 100, 400 are able to operate in the same manner and be incorporated into other vehicles or devices to provide a ratchet mechanism/function. Further, although the assemblies 1, 301 are described herein with respect to a rear wheel, it is understood that the assemblies 1, 301, hub shell assemblies 30, 330 and/or the freehub assemblies 100, 400 are able to operate in the same manner and be incorporated into other wheels and/or non- wheels using axle/rotation based mechanisms the require a ratcheting function. Additionally, although the hub assembly 301 is described herein as having three primary pawls forming three openings of different or the same sizes and a pawl actuation assembly having three lobes to fit within those openings, more or less primary pawls, openings and lobes are contemplated. Also, it should be noted that although described separately, the features of the various assemblies 440, 750 and 760 are able to all be combined in to a single assembly, or any combination of two of the assemblies.

In addition, it is understood that the assemblies described herein are each able to easily be envisioned in a reversed assembly, where the ratchet teeth are mounted rigidly on the freehub body, with teeth facing either external to the axis of rotation or internal facing, and the pawls could be mounted movably on the hub shell. In this configuration the pawl moving feature, analogous to the actuator, is able to be activated by a clutch mounted to the inside of the freehub body. In some embodiments, the ratchet ring 480 is able to be divided into two ratchet rings having a matching size and shape positioned adjacent to each other. In such embodiments, one of the ratchet rings is able to be positioned adjacent to and operatively couple with the actuator ratchet pawl 450 (which is able to be offset from the primary pawls 406a-c) and the other ratchet ring is able to be positioned adjacent to and operatively couple with primary pawls 406a-c. As a result, the materials used for the ratchet rings are able to be different (e.g. the ratchet ring coupled with the actuator ratchet pawl 450 is able to be made of plastic or noise reducing material). For some alternative embodiments utilizing face gears, it could be envisioned that the lobed interface between one face gear could be located between the hub shell face gear and the hub shell itself, such that the deadband is developed between those two parts. It should also be clear that the bearing arrangement in the hub is able to be arranged in any practical way that supports the functional components in an analogous relationship to one another. Finally, although the system, method and device are described primarily in relation to a bicycle, the system, method and device is able to apply to any vehicle or other type of device using hubs and/or any number of wheels.

What is claimed is:

1. A hub system, the system comprising:
a wheel including a hub shell assembly, the hub shell assembly having a central aperture for receiving an axle, a ratchet gear bore and a toothed ratchet gear positioned within the ratchet gear bore;
a freehub assembly including an outer hub sprocket attachment feature and a pawl support member, the pawl support member having a central axis, a plurality of pawl coupling bases and a plurality of primary pawls pivotably coupled to the pawl coupling bases along an arc about the central axis; and
a pawl actuator assembly having an actuator body, a central hole extending through the actuator body for receiving the axle and a plurality of lobes protruding from a perimeter of the actuator body away from the central hole, wherein at least one of the lobes includes a ratchet member that extends from the at least one lobe away from the central hole; wherein the plurality of primary pawls are positioned within the toothed ratchet gear, each lobe of the lobes of the pawl actuator assembly is positioned along the arc between two of the primary pawls, and when the hub shell assembly moves about the central aperture in a first direction relative to the pawl actuator assembly, the ratchet member slidably contacts the toothed ratchet gear and the primary pawls do not contact the toothed ratchet gear.

2. The system of claim 1, wherein when the hub shell assembly rotates about the central aperture in a second direction relative to the pawl actuator assembly, the ratchet member engages a tooth of the toothed ratchet gear such that the pawl actuator assembly begins to move with the hub shell assembly about the central aperture relative to the freehub assembly.

3. The system of claim 2, wherein upon contacting the primary pawls when moving in the second direction, the lobes of the pawl actuator assembly cause the primary pawls to pivot away from the central axis until the primary pawls each engage a different tooth of the toothed ratchet gear.

4. The system of claim 1, wherein the pawl support member has a plurality of openings along the arc having differing lengths, wherein each of the openings are bound by a tip of one of the primary pawls and an end wall of the pawl coupling base adjacent to the tip of the one of the primary pawls.

5. The system of claim 1, wherein the ratchet member is an extra pawl coupled within a pivoting channel in the at least one of the lobes.

6. The system of claim 1, wherein the ratchet member is a spring coupled within a holding cavity in the at least one of the lobes.

7. The system of claim 1, wherein the ratchet member is a flexible protrusion formed by an extension of the at least one of the lobes.

8. The system of claim 1, wherein the freehub assembly further comprises at least one biasing member that applies a biasing force to the plurality of primary pawls that resists the pivoting of the plurality of primary pawls away from the central axis of the freehub assembly.

9. The system of claim 8, wherein the plurality of primary pawls are magnetic and the at least one biasing member is a plurality of magnets positioned within recesses within the pawl support member adjacent to the plurality of primary pawls.

10. The system of claim 9, wherein the position of the recesses within the pawl support member is offset from a midline of the plurality of primary pawls such that the magnets provide a magnetic force biasing the plurality of primary pawls into the pawl coupling bases.

11. The system of claim 8, wherein the biasing member is a spring that surrounds the plurality of primary pawls.

12. The system of claim 1, wherein the lobes each include a flexible leaf spring that cushions contact between tips of the primary pawls and the lobes.

13. A hub assembly, the hub assembly comprising:
a toothed ratchet gear;
a freehub assembly including an outer hub sprocket attachment feature and a pawl support member, the pawl support member having a central axis, a plurality of pawl coupling bases and a plurality of primary pawls pivotably coupled to the pawl coupling bases along an arc about the central axis; and
a pawl actuator assembly having an actuator body, a central hole extending through the actuator body and a plurality of lobes protruding from a perimeter of the actuator body away from the central hole, wherein at least one of the lobes includes a ratchet member that extends from the at least one lobe away from the central hole;
wherein the plurality of primary pawls are positioned within the toothed ratchet gear, each lobe of the lobes of the pawl actuator assembly is positioned along the arc between two of the primary pawls, and when the toothed ratchet gear moves about the central axis in a first direction relative to the pawl actuator assembly, the ratchet member slidably contacts the toothed ratchet gear and the primary pawls do not contact the toothed ratchet gear.

14. The assembly of claim 13, wherein when the toothed ratchet gear rotates about the central axis in a second direction relative to the pawl actuator assembly, the ratchet member engages a tooth of the toothed ratchet gear such that the pawl actuator assembly begins to move with the toothed ratchet gear about the central aperture relative to the freehub assembly.

15. The assembly of claim 14, wherein upon contacting the primary pawls when moving in the second direction, the lobes of the pawl actuator assembly cause the primary pawls to pivot away from the central axis until the primary pawls each engage a different tooth of the toothed ratchet gear.

16. The assembly of claim 13, wherein the pawl support member has a plurality of openings along the arc having differing lengths, wherein each of the openings are bound by a tip of one of the primary pawls and an end wall of the pawl coupling base adjacent to the tip of the one of the primary pawls.

17. The assembly of claim 13, wherein the ratchet member is an extra pawl coupled within a pivoting channel in the at least one of the lobes.

18. The assembly of claim 13, wherein the ratchet member is a spring coupled within a holding cavity in the at least one of the lobes.

19. The assembly of claim 13, wherein the ratchet member is a flexible protrusion formed by an extension of the at least one of the lobes.

20. The assembly of claim 13, wherein the freehub assembly further comprises at least one biasing member that applies a biasing force to the plurality of primary pawls that resists the pivoting of the plurality of primary pawls away from the central axis of the freehub assembly.

21. The assembly of claim 20, wherein the plurality of primary pawls are magnetic and the at least one biasing member is a plurality of magnets positioned within recesses within the pawl support member adjacent to the plurality of primary pawls.

22. The assembly of claim 21, wherein the position of the recesses within the pawl support member is offset from a midline of the plurality of primary pawls such that the magnets provide a magnetic force biasing the plurality of primary pawls into the pawl coupling bases.

23. The assembly of claim 20, wherein the biasing member is a spring that surrounds the plurality of primary pawls.

24. The assembly of claim 13, wherein the lobes each include a flexible leaf spring that cushions contact between tips of the primary pawls and the lobes.

25. A method of providing a hub system, the method comprising:
providing a toothed ratchet;
providing a freehub assembly including an outer hub sprocket attachment feature and a pawl support member, the pawl support member having a central axis, a plurality of pawl coupling bases and a plurality of primary pawls pivotably coupled to the pawl coupling bases along an arc about the central axis;
providing a pawl actuator assembly having an actuator body, a central hole extending through the actuator body and a plurality of lobes protruding from a perimeter of the actuator body away from the central hole, wherein at least one of the lobes includes a ratchet member that extends from the at least one lobe away from the central hole;
coupling the freehub assembly with the toothed ratchet such that the plurality of primary pawls are positioned within the toothed ratchet gear; and
coupling the pawl actuator assembly with the freehub assembly such that each lobe of the lobes of the pawl actuator assembly is positioned along the arc between two of the primary pawls, wherein when the hub shell assembly moves about the central axis in a first direction relative to the pawl actuator assembly, the ratchet member slidably contacts the toothed ratchet gear and the primary pawls do not contact the toothed ratchet gear.

26. The method of claim 25, wherein when the hub shell assembly rotates about the central axis in a second direction relative to the pawl actuator assembly, the ratchet member engages a tooth of the toothed ratchet gear such that the pawl actuator assembly begins to move with the hub shell assembly about the central aperture relative to the freehub assembly.

27. The method of claim 26, wherein upon contacting the primary pawls when moving in the second direction, the lobes of the pawl actuator assembly cause the primary pawls to pivot away from the central axis until the primary pawls each engage a different tooth of the toothed ratchet gear.

28. The method of claim 25, wherein the pawl support member has a plurality of openings along the arc having differing lengths and each of the openings are bound by a tip of one of the primary pawls and an end wall of the pawl coupling base adjacent to the tip of the one of the primary pawls, further comprising adjusting a deadband of the hub by positioning the at least one of the lobes within the one of the openings having a length that corresponds to a desired deadband.

29. The method of claim 25, wherein the ratchet member is an extra pawl coupled within a pivoting channel in the at least one of the lobes.

30. The method of claim 25, wherein the ratchet member is a spring coupled within a holding cavity in the at least one of the lobes.

31. The method of claim 25, wherein the ratchet member is a flexible protrusion formed by an extension of the at least one of the lobes.

32. The method of claim 25, wherein the freehub assembly further comprises at least one biasing member that applies a biasing force to the plurality of primary pawls that resists the pivoting of the plurality of primary pawls away from the central axis of the freehub assembly.

33. The method of claim 32, wherein the plurality of primary pawls are magnetic and the at least one biasing member is a plurality of magnets positioned within recesses within the pawl support member adjacent to the plurality of primary pawls.

34. The method of claim 33, wherein the position of the recesses within the pawl support member is offset from a midline of the plurality of primary pawls such that the magnets provide a magnetic force biasing the plurality of primary pawls into the pawl coupling bases.

35. The method of claim 32, wherein the biasing member is a spring that surrounds the plurality of primary pawls.

36. The method of claim 25, wherein the lobes each include a flexible leaf spring that cushions contact between tips of the primary pawls and the lobes.

37. A pawl actuator assembly for use in a hub, the assembly comprising:
an actuator body having an inner bore and a central hole extending through the actuator body for receiving an axle;
a bearing positioned within the inner bore and about the central hole; and
a plurality of equidistant lobes protruding from a perimeter of the actuator body away from the central hole, wherein at least one of the lobes includes a ratchet member that extends from the at least one lobe away from the central hole.

38. A hub system, the system comprising:
a wheel including a hub shell assembly, the hub shell assembly having a central aperture for receiving an axle, a driving face gear bore and a driving face radial gear having an inner cavity face with a set of driving teeth, wherein the driving face gear is positioned within the driving face gear bore; and
a freehub assembly including an outer hub sprocket attachment feature, an actuator face radial gear and a face gear support structure having a plurality of deadband grooves, wherein the actuator face gear has a first face including a plurality of actuator teeth and a second face having a plurality of deadband lobes positioned within the deadband grooves;
wherein the actuator face radial gear is positioned within the driving face gear such that the plurality of actuator teeth contact the set of driving teeth, wherein when the hub shell assembly moves about the central aperture in a first direction relative to the freehub assembly, the actuator teeth slide past the driving teeth without engaging the driving teeth, and further wherein when the hub shell assembly moves about the central aperture in a second direction relative to the freehub assembly, the actuator teeth engage the driving teeth such that the hub shell assembly and the actuator face gear move together.
